(19) United States
(12) Patent Application Publication
(10) Pub. No.: US 2011/0174340 A1
(43) Pub. Date: Jul. 21, 2011

(54) LOW AND HIGH TEMPERATURE ENZYMATIC SYSTEM

(75) Inventors: Barbara G. Choczaj, Apple Valley, MN (US); Mark Peterson, Prior Lake, MN (US); Bruce White, Hugo, MN (US); Beth Benson, Minneapolis, MN (US); Eric Willman, White Bear Lake, MN (US)

(73) Assignee: Ecolab USA, St. Paul, MN (US)

(21) Appl. No.: 12/690,438

(22) Filed: Jan. 20, 2010

(51) Int. Cl. C11D 3/386; B08B 3/00

(52) U.S. Cl. 134/26; 510/161

(57) ABSTRACT

An enzymatic system includes a first pH neutral composition and a second pH neutral composition. The first pH neutral composition includes a low temperature enzyme effective at removing blood and hemoglobin. The second pH neutral composition includes a high temperature enzyme effective at removing mucous, fibrin and fat. In one embodiment, the low temperature enzyme has an activation temperature of about 50 degrees to about 120 degrees Fahrenheit and the high temperature enzyme has an activation temperature of about 140 to about 180 degrees Fahrenheit.

### TECHNICAL FIELD

The present invention is related generally to the field of enzymatic detergents. In particular, the present invention is an enzymatic detergent system including a low temperature enzymatic composition and a high temperature enzymatic composition and method of cleaning surgical devices or instruments using the enzymatic detergent system.

### BACKGROUND

Surgical devices and instruments used in the healthcare industry that are designed to be washed and re-used require proper cleaning in order to meet health code requirements recommended by the American Association for the Advancement of Medical Instruments (AAMI) and the Association of Operating Room Nurses (AORAN) in removing biomass such as mucous, fibrin, fats and hemoglobin from the devices after completion of the medical procedure. Generally, after the surgical device has been used, it is placed in a container and sprayed with a liquid to prevent soils from hardening as a denaturing process. The device is then taken to a sterilization area to be cleaned. After a manual pre-cleaning step, the devices are sorted and again placed in a wire basket. The surgical device is then placed into an automated reprocessing washer disinfector for cleaning.

In the automated reprocessing washer disinfector, the surgical device is exposed to various cleaning regimen. Typically, the devices are first sprayed with a first wash solution, which may include a pre-soak solution or a low temperature mechanical wash solution. After being sprayed with the first wash solution, the devices are washed with a second wash solution, or a main detergent wash. Generally, the first wash step uses cold tap water at a temperature of about 50 degrees Fahrenheit (° F.) to about 120° F. The first wash step is carried out at lower temperatures because blood is generally easier to remove using cold water. In order to help further facilitate the removal of blood and hemoglobin during the first wash step, current pre-soak detergents may include enzyme or enzymes.

The second wash step typically uses water heated to a temperature of about 140° F. to about 180° F. in order to facilitate removal of biomass from the surgical device. After the second wash step, the surgical device is then subjected to a series of rinses in order to rinse off the detergent compositions. For example, the washer may include a hot water rinse, a thermal rinse and a pure water rinse. During the thermal rinsing step, the water is heated to a temperature of about 180° F. Deionized or purified water is used during the pure water rinsing step. One of the last steps in reprocessing the surgical device may be a lubrication step to ensure proper lubrication, therefore prolonging the shelf life of the surgical device or instrument. After cleaning, the surgical device is moved to another area to be disinfected.

### SUMMARY

In one embodiment, the present invention is an enzymatic system including a first composition and a second composition. The first composition includes a low temperature enzyme effective at removing blood and hemoglobin. The second composition includes a high temperature enzyme effective at removing mucous, fibrin and fat.

In another embodiment, the present invention is a detergent system for cleaning instruments. The detergent system includes a first pH neutral enzymatic composition and a second pH neutral enzymatic composition. Each of the first and second enzymatic composition includes about 5% to about 20% of an enzyme.

In yet another embodiment, the present invention is a method of cleaning a surgical instrument. The method includes contacting the surgical instrument in a first enzymatic composition, washing the surgical instrument in a second enzymatic composition and rinsing the surgical instrument.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION

The present invention relates to an enzymatic system and methods of using the enzymatic system for removing soils from a surgical device or instrument. The enzymatic system is effective at cleaning soils such as proteins, biomass, fibrin, mucous, fats, carbohydrates and hemoglobin typically found during clinical procedures. The enzymatic system also creates minimal fast breaking foam to no foam, is hard water tolerant, does not contribute to scaling and is safe to use on various surfaces. For example, the enzymatic system is compatible with stainless steel, brass, copper, soft metals including aluminum, and plastics. The enzymatic system includes a first pH neutral enzymatic composition used during a first washing step, such as a pre-soaking step or a low temperature mechanical washing step, of a wash cycle and a second pH neutral enzymatic composition used during a second washing step, such as a main detergent wash step or a high temperature washing step, of a wash cycle. In one embodiment, the enzymatic system is substantially free of surfactants and phosphorus-containing compounds and is fully biodegradable. The enzymatic system is effective within a wide range of water hardness conditions and can be used in various industries, including, but not limited to, the healthcare industry. For example, the enzymatic system can be used in healthcare cleaning applications including, but not limited to, surgical devices. In particular, the enzymatic system is designed for use in hospital washer/disinfector units and automated mechanical washers for processing appropriate medical devices, including surgical instruments. Although the enzymatic system is described as being used in the healthcare industry to clean surgical instruments and devices, the enzymatic system may be used in any industry in which it is desired to remove proteins, biomass, fibrin, mucous, fats, carbohydrates and hemoglobin from a surface.

In one embodiment, the enzymatic system creates little foam, making it compatible for use with a manual sink or an automatic instrument re-processor application. It is particularly beneficial for the compositions to be low foaming in an instrument care environment. For example, when manually cleaning surgical devices or instruments, it is advantageous for the technicians to be able to see the instruments when they are submerged so that they do not cut or otherwise injure themselves when reaching into the sink In the field of instrument reprocessing, low foaming compositions allow the machine to properly and easily rinse away the compositions from the surgical devices or instruments and properly clean them. In addition, high foaming detergent compositions will lower the automated washer pressure capabilities as well.

In one embodiment, the enzymatic system includes a first enzymatic composition and a second enzymatic composition. Both of the enzymatic compositions includes an enzyme with one or more of an enzyme stabilizing agent, a filler, a solidification agent, a chelating agent, a water conditioning agent, a builder, a processing agent and a preservative. The first enzymatic composition includes an enzyme that is activated at low temperatures and the second enzymatic composition includes an enzyme that is activated at high temperatures. For example, the enzyme of the first enzymatic composition is activated at temperatures of about 50° F. to about 120° F. and the enzyme of the second enzymatic composition is activated at temperatures of about 140° F. to about 180° F. The pH of the enzymatic compositions ensures the preservation of the enzymes and should be in the neutral range. Both the first and second enzymatic compositions have a neutral pH of about 5 to about 9. In particular, the pH of the enzymatic compositions is about 8 to about 9.

### Enzymes

Enzymes are extremely effective catalysts. In practice, very small amounts will accelerate the rate of soil degradation and soil alteration reactions without themselves being consumed in the process. The enzymes used in the present invention function to degrade or alter one or more types of soil residues encountered on a surface, thus removing the soil or making the soil more removable by another component of the enzymatic systems. In particular, the enzymes used in the present invention provide desirable activity for removal of biomass such as mucous, fibrin, fats and hemoglobin from substrates. Both degradation and alteration of soil residues can improve detergency by reducing the physicochemical forces which bind the soil to the surface or textile being cleaned, i.e. the soil becomes more water soluble. For example, one or more proteases can cleave complex, macromolecular protein structures present in soil residues into simpler short chain molecules which are, of themselves, more readily desorbed from surfaces, solubilized or otherwise more easily removed by detersive solutions containing said proteases.

The enzymes are selected based on the type of soil targeted by the composition or present at the site or surface to be cleaned. In the enzymatic system of the present invention, a low temperature enzyme is used for cleaning blood and hemoglobin and a high temperature enzyme is used for cleaning mucous, fibrin and fats. In an exemplary enzymatic system of the present invention, the first enzymatic composition, which is used in a cold pre-soaking or washing step, includes a low temperature functioning enzyme and the second enzymatic composition, which is used in the warm main detergent wash step, includes a high temperature functioning enzyme. In one embodiment, a low temperature functioning enzyme is an enzyme having an activation temperature of about 50° F. to about 120° F. and a high temperature functioning enzyme is an enzyme having an activation temperature of about 140° F. to about 180° F.

Enzymes which degrade or alter one or more types of soil, i.e. augment or aid the removal of soils from surfaces to be cleaned, are identified and can be grouped into six major classes on the basis of the types of chemical reactions which they catalyze in such degradation and alteration processes. These classes are (1) oxidoreductase; (2) transferase; (3) hydrolase; (4) lyase; (5) isomerase; and (6) ligase. Several enzymes may fit into more than one class. A valuable reference on enzymes is “Industrial Enzymes”, Scott, D., in Kirk-Othmer Encyclopedia of Chemical Technology, 3rd Edition, (editors Grayson, M. and EcKroth, D.) Vol. 9, pp. 173-224, John Wiley & Sons, New York, 1980.

In general, the oxidoreductases, hydrolases, lyases and ligases degrade soil residues thus removing the soil or making the soil more removable; and transferases and isomerases alter soil residues with the same effect. Of these enzyme classes, the hydrolases (including esterase, carbohydrase or protease) are particularly suitable for the present invention.

The hydrolases catalyze the addition of water to the soil with which they interact and generally cause a degradation or breakdown of that soil residue. This breakdown of soil residue is of particular and practical importance in detergent applications because soils adhering to surfaces are loosened and removed or rendered more easily removed by detersive action. Thus, hydrolases are a suitable class of enzymes for use in cleaning compositions. Particularly suitable hydrolases include, but are not limited to: esterases, carbohydrases, and proteases. In particular, proteases are suitable for the compositions of the present invention.

The proteases catalyze the hydrolysis of the peptide bond linkage of amino acid polymers. For example, the proteases can catalyze peptides, polypeptides, proteins and related substances, generally protein complexes, such as casein which contains carbohydrate (glyco group) and phosphorus as integral parts of the protein and exists as distinct globular particles held together by calcium phosphate. Other globular particles include milk globulins which can be thought of as protein and lipid sandwiches that include the milk fat globule membrane. Proteases thus cleave complex, macromolecular protein structures present in soil residues into simpler short chain molecules which are, of themselves, more readily desorbed from surfaces, solubilized or otherwise more easily removed by detersive solutions containing said proteases.

Proteases are further divided into three distinct subgroups which are grouped by the pH optima (i.e. optimum enzyme activity over a certain pH range). These three subgroups are the alkaline, neutral and acids proteases. Particularly suitable for this invention are pH neutral proteases.

The enzymatic system of the present invention particularly includes at least one protease. Particularly, the enzymatic system includes a low temperature protease in the first enzymatic composition and a high temperature protease in the second enzymatic composition. The enzymatic system of the invention has further been found, surprisingly, not only to stabilize protease for a substantially extended shelf life, but also to significantly enhance protease activity toward digesting proteins and enhancing soil removal. Further, enhanced protease activity occurs in the presence of one or more additional enzymes, such as amylase, cellulase, lipase, peroxidase, endoglucanase enzymes and mixtures thereof, particularly lipase or amylase enzymes.

Examples of commercially available proteolytic enzymes which can be employed in the composition of the invention include (with trade names) Savinase®; a protease derived from Bacillus lentos type, such as Maxacal®, Opticlean®, Durazym®, and Properase®; a protease derived from Bacillus licheniformis, such as Alcalase®, and Maxatase®; and a protease derived from Bacillus amyloliquefaciens, such as Primase®. Particularly suitable commercially available protease enzymes include those sold under the trade names Alcalase®, Savinase®, Primase®, Durazym®, or Esperase® by Novoenzymes (Denmark); those sold under the trade names Maxatase®, Maxacal®, or Maxapem® by Gist-Brocades (Netherlands); those sold under the trade names Purafect®, Purafect OX, and Properase by Genencor International; those sold under the trade names Opticlean® or Optimase® by Solvay Enzymes; and the like. A mixture of such proteases can also be used. For example, Alcalase® is a particularly suitable protease for use in the first wash step of the wash cycle, having application in lower temperature cleaning programs, for example from about 70° F. to about 120° F. Esperase® is a protease of choice for higher temperature detersive solutions, for example from about 140° F. to about 170° F. Suitable detersive proteases are described in patent publications including: GB 1,243,784, WO 9203529 A (enzyme/inhibitor system), WO 9318140 A, and WO 9425583 (recombinant trypsin-like protease) to Novoenzymes; WO 9510591 A, WO 9507791 (a protease having decreased adsorption and increased hydrolysis), WO 95/30010, WO 95/30011, WO 95/29979, to Procter & Gamble; WO 95/10615 (Bacillus amyloliquefaciens subtilisin) to Genencor International; EP 130,756 A (protease A); EP 303,761 A (protease B); and EP 130,756 A. A variant protease employed in the present solid compositions is preferably at least 80% homologous, preferably having at least 80% sequence identity, with the amino acid sequences of the proteases in these references.

Lipase enzymes suitable for the composition of the present invention can be derived from a plant, an animal, or a microorganism. Because lipases can also be advantageous for cleaning soils containing fat, oil, or wax, such as animal or vegetable fat, oil, or wax (e.g., salad dressing, butter, lard, chocolate, lipstick), lipases can be used as the enzyme in the second enzymatic composition. In addition, cellulases can be advantageous for cleaning soils containing cellulose or containing cellulose fibrin that serve as attachment points for other soil. Suitable lipases include those derived from a Pseudomonas, such as Pseudomonas stutzeri ATCC 19.154, or from a Humicola, such as Humicola lanuginosa (typically produced recombinantly in Aspergillus oryzae). The lipase can be pure or a component of an extract, and either wild or a variant (either chemical or recombinant).

Examples of lipase enzymes that can be employed in the composition of the invention include those sold under the trade names Lipase P “Amano” or “Amano-P” by Amano Pharmaceutical Co. Ltd., Nagoya, Japan or under the trade name Lipolase® by Novoenzymes, and the like. Other commercially available lipases that can be employed in the present solid compositions include Amano-CES, lipases derived from Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., and lipases derived from Pseudomonas gladioli or from Humicola lanuginosa.

A suitable lipase is sold under the trade name Lipolase® by Novoenzymes. Suitable lipases are described in patent documents including: WO 9414951 A (stabilized lipases) to Novoenzymes, WO 9205249, RD 94359044, GB 1,372,034, Japanese Patent Application 53,20487, laid open Feb. 24, 1978 to Amano Pharmaceutical Co. Ltd., and EP 341,947. For example, a lipase may be used in the washing step to remove mucous, fats and fibrin.

Amylases suitable for the composition of the present invention can be derived from a plant, an animal, or a microorganism. The amylase can be pure or a component of a microbial extract, and either wild or a variant (either chemical or recombinant), particularly a variant that is more stable under washing or presoak conditions than a wild type amylase. Examples of amylase enzymes that can be employed in the enzymatic system of the present invention include those sold under the trade name Rapidase by Gist-Brocades® (Netherlands); those sold under the trade names Termamyl®, Fungamyl® or Duramyl® by Novoenzymes; Purastar STL or Purastar OXAM by Genencor; and the like. Particularly suitable commercially available amylase enzymes include the stability enhanced variant amylase sold under the trade name Duramyl® by Novoenzymes. A mixture of amylases can also be used. Amylases suitable for the compositions of the present invention include: α-amylases described in WO 95/26397, PCT/DK96/00056, and GB 1,296,839 to Novoenzymes; and stability enhanced amylases described in J. Biol. Chem., 260(11):6518-6521 (1985); WO 9510603 A, WO 9509909 A and WO 9402597 to Novoenzymes; references disclosed in WO 9402597; and WO 9418314 to Genencor International. A variant α-amylase employed in the present solid compositions can be at least 80% homologous, preferably having at least 80% sequence identity, with the amino acid sequences of the proteins of these references.

Cellulases suitable for the composition of the present invention can be derived from a plant, an animal, or a microorganism. The cellulase can be purified or a component of a microbial extract, and either wild type or variant (either chemical or recombinant), particularly a variant that is more stable under washing or presoak conditions than a wild type amylase. Examples of cellulase enzymes that can be employed in the composition of the invention include those sold under the trade names Carezyme® or Celluzyme® by Novoenzymes, or Cellulase by Genencor; and the like. A mixture of cellulases can also be used. Suitable cellulases are described in patent documents including: U.S. Pat. No. 4,435,307, GB-A-2.075.028, GB-A-2.095.275, DE-OS-2.247.832, WO 9117243, and WO 9414951 A (stabilized cellulases) assigned to Novoenzyme.

Additional enzymes suitable for use in the present solid compositions include a cutinase, a peroxidase, a gluconase, and the like and can be derived from a plant, an animal, or a microorganism. The enzyme can be pure or a component of a microbial extract, and either wild or a variant (either chemical or recombinant), particularly a variant that is more stable under washing or presoak conditions than a wild type amylase.

Mixtures of different additional enzymes can be incorporated into the present invention. While various specific enzymes have been described above, it is to be understood that any additional enzyme which can confer the desired enzyme activity to the composition can be used and this embodiment of this invention is not limited in any way by a specific choice of enzyme.

### Enzyme Stabilization System

Each of the first and second enzymatic compositions of the enzymatic system also includes an enzyme stabilization system to stabilize the enzyme or enzymes in each composition. For example, the enzymatic system of the invention can include a water-soluble source of calcium and/or magnesium ions. Calcium ions are generally more effective than magnesium ions and are suitable herein if only one type of cation is being used. Compositions, especially liquids, can include from about 1 to about 30, particularly from about 2 to about 20, more particularly from about 8 to about 12 millimoles of calcium ions per liter of finished composition, though variation is possible depending on factors including the multiplicity, types and levels of enzymes incorporated. Particularly, water-soluble calcium or magnesium salts are employed, including for example calcium chloride, calcium hydroxide, calcium formate, calcium malate, calcium maleate, calcium hydroxide and calcium acetate. More generally, calcium sulfate or magnesium salts corresponding to the listed calcium salts may be used. Further increased levels of calcium and/or magnesium may be useful, for example to promote the grease-cutting action of certain types of surfactant.

Examples of suitable enzyme stabilization systems include, but are not limited to: sodium sulfate, available from Giles Chemical Industries and calcium chloride dehydrate, available from Dow Chemical Company.

### Filler

The enzymatic system includes an effective amount of detergent fillers, which do not perform as a cleaning agent per se, but cooperate with the cleaning agent to enhance the overall cleaning capacity of the composition. Examples of detergent fillers suitable for use in the present cleaning compositions include sodium sulfate, sodium chloride, starch, sugars, C₁-C₁₀ alkylene glycols such as propylene glycol, and the like. Examples of commercially available fillers include, but are not limited to, sodium sulfate available from Giles Chemical Industries and sodium gluconate available from Jungbunzlauer Inc.

### Solidification Agent

The enzymatic system also includes a solidification agent in addition to, or in the form of, a builder. A solidification agent is a compound or system of compounds, organic or inorganic, which significantly contributes to the uniform solidification of the composition. The solidification agents are compatible with the cleaning agent and other active ingredients of the composition and are capable of providing an effective amount of hardness and/or aqueous solubility to the processed composition. The solidification agents should also be capable of forming a homogeneous matrix with the other components when mixed and solidified to provide a uniform dissolution of the components from the solid composition during use.

The amount of solidification agent included in the solid detergent composition will vary according to factors including, but not limited to: the type of solid composition being prepared, the components of the solid composition, the intended use of the solid composition, the quantity of dispensing solution applied to the solid composition over time during use, the temperature of the dispensing solution, the hardness of the dispensing solution, the physical size of the solid composition and the concentration of the other components. In particular, the amount of the solidification agent included in the enzymatic system is effective to combine with the other components to form a homogeneous mixture under continuous mixing conditions and a temperature at or below the melting temperature of the solidification agent.

The solidification agent forms a matrix with the other components and hardens to a solid form under ambient temperatures of about 30° C. to about 50° C. and particularly about 35° C. to about 45° C. The mixture is dispensed from the mixing system within about 1 minute to about 3 hours, particularly about 2 minutes to about 2 hours, and particularly about 5 minutes to about 1 hour after mixing ceases. A minimal amount of heat from an external source may be applied to the mixture to facilitate processing of the mixture. It is preferred that the amount of the solidification agent included in the composition is effective to provide a desired hardness and desired rate of controlled solubility of the processed composition when placed in an aqueous medium to achieve a desired rate of dispensing from the solidified composition during use.

The solidification agent may be an organic or an inorganic hardening agent. A suitable organic hardening agent is a polyethylene glycol (PEG) compound. The solidification rate of solid compositions including a polyethylene glycol hardening agent will vary, at least in part, according to the amount and the molecular weight of the polyethylene glycol added to the composition. Examples of suitable polyethylene glycols include, but are not limited to: solid polyethylene glycols of the general formula H(OCH₂CH₂)ₙOH, where n is greater than 15, particularly about 30 to about 1700. Typically, the polyethylene glycol is a solid in the form of flakes or a free-flowing powder, having a molecular weight of about 1,000 to about 100,000, particularly having a molecular weight of at least about 1,450 to about 20,000, more particularly about 1,450 to about 8,000. The polyethylene glycol is present at a concentration of from about 2% to about 30% by weight, particularly about 2.4% to about 25% and more particularly about 3% to about 22% by weight. Suitable polyethylene glycol compounds include, but are not limited to: PEG 4000, PEG 1450, and PEG 8000 among others, with PEG 4000 and PEG 8000 being most preferred. An example of a commercially available solid polyethylene glycol is polyethylene glycol, available from BASF Corporation.

Suitable inorganic solidification agents are hydratable inorganic salts, including, but not limited to: sulfates and bicarbonates.

Urea particles can also be employed as solidification agents. The solidification rate of the compositions will vary, at least in part, to factors including, but not limited to: the amount, the particle size, and the shape of the urea added to the composition. For example, a particulate form of urea can be combined with other components, and optionally a minimal but effective amount of water. The amount and particle size of the urea is effective to combine with the other components to form a homogeneous mixture without the application of heat from an external source to melt the urea and other ingredients to a molten stage. The amount of urea included in the solid composition is effective to provide a desired hardness and desired rate of solubility of the composition when placed in an aqueous medium to achieve a desired rate of dispensing the cleaning agent from the solidified composition during use.

### Chelating Agent

The chelating or sequestering agent aids in removing metal compound soils and in reducing harmful effects of hardness components in service water. Polyvalent metal cations or compounds such as a calcium, a magnesium, an iron, a manganese, a molybdenum, etc. cation or compound, or mixtures thereof, can be present in service water and in complex soils. Such compounds or cations can interfere with the effectiveness of a washing or rinsing composition during a cleaning application. A chelating agent can effectively complex and remove such compounds or cations from soiled surfaces and can reduce or eliminate the inappropriate interaction with active ingredients including the nonionic surfactants and anionic surfactants of the invention. Both organic and inorganic chelating agents are common and can be used. Inorganic chelating agents include such compounds as sodium tripolyphosphate and other higher linear and cyclic polyphosphates species. Organic chelating agents include both polymeric and small molecule chelating agents. Organic small molecule chelating agents are typically organocarboxylate compounds or organophosphate chelating agents. Polymeric chelating agents commonly comprise polyanionic compositions such as polyacrylic acid compounds. Small molecule organic chelating agents include, but are not limited to: sodium gluconate, sodium glucoheptonate, N-hydroxyethylenediaminetriacetic acid (HEDTA), ethylenediaminetetraacetic acid (EDTA), nitrilotriaacetic acid (NTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available. An example of a suitable commercially known chelating agent includes, but is not limited to, Dissolvine GL PD, available from Azko Nobel. An example of a suitable commercially available iron chelating agent includes sodium gluconate, available from Jungbunzlauer Inc.

### Builder

The enzymatic system also includes builders and auxiliaries typically employed in such cleaning preparations. Examples of suitable builders which may be used include, but are not limited to: silicates and citrates. Similarly, examples of suitable auxiliaries which may be used include, but are not limited to: sodium hydroxide, potassium hydroxide, TEA and MEA. An example of a suitable commercially available builder includes, but is not limited to, Acusol 445ND, available from Rohm & Haas.

### Water Conditioning Agent

Water conditioning polymers can be used as non-phosphorus containing builders. Exemplary water conditioning polymers include, but are not limited to, polycarboxylates. Exemplary polycarboxylates that can be used as builders and/or water conditioning polymers include, but are not limited to those having pendant carboxylate (—CO₂⁻) groups such as: polyacrylic acid, maleic acid, maleic/olefin copolymer, sulfonated copolymer or terpolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, and hydrolyzed acrylonitrile-methacrylonitrile copolymers. An example of a particularly suitable water conditioning agent includes, but is not limited to, sodium citrate dehydrate.

### Solvent or Processing Agent

The enzymatic system also includes a solvent or processing agent to increase the ability of the compositions to be processed. An example of a particularly suitable solvent or processing agent includes, but is not limited to, propylene glycol.

### Preservative

The enzymatic system also includes a preservative to prevent decomposition by microbial growth or by undesirable chemical changes. An example of a particularly suitable preservative includes, but is not limited to, 1, 2 benzisothiazolin-3-(2H)-one. Exemplary commercially available 1, 2 benzisothiazolin-3-(2H)-one include, but are not limited to, Proxel GXL and Acticide B 20.

In one embodiment, the enzymatic system of the present invention is substantially free of phosphorus-containing compounds, making the enzymatic system more environmentally acceptable. Phosphorus-free refers to a composition, mixture, or ingredient to which phosphorus-containing compounds are not added. Should phosphorus-containing compounds be present through contamination of a phosphorus-free composition, mixture, or ingredient, the level of phosphorus-containing compounds in the resulting composition is less than about 0.5 wt %, less than about 0.1 wt %, and often less than about 0.01 wt %.

In one embodiment, the enzymatic system of the present invention is substantially free of surfactants. Surfactant-free refers to a composition, mixture, or ingredient to which surfactants are not added. Should surfactants be present through contamination of a surfactants-free composition, mixture, or ingredient, the level of surfactants in the resulting composition is less than about 0.5 wt %, less than about 0.1 wt %, and often less than about 0.01 wt %.

### Additional Functional Materials

The enzymatic system can include additional components or agents, such as additional functional materials. As such, in some embodiments, the enzymatic system including the first enzymatic composition and the second enzymatic composition may provide a large amount, or even all of the total weight of the enzymatic system, for example, in embodiments having few or no additional functional materials disposed therein. The functional materials provide desired properties and functionalities to the enzymatic system. For the purpose of this application, the term “functional materials” includes a material that when dispersed or dissolved in a use and/or concentrate solution, such as an aqueous solution, provides a beneficial property in a particular use. The preparations containing the first enzymatic composition and the second enzymatic composition may optionally contain other soil-digesting components, disinfectants, sanitizers, acidulants, complexing agents, corrosion inhibitors, foam inhibitors, dyes, thickening or gelling agents, and perfumes. Some particular examples of functional materials are discussed in more detail below, but it should be understood by those of skill in the art and others that the particular materials discussed are given by way of example only, and that a broad variety of other functional materials may be used.

### Sanitizers/Anti-Microbial Agents

The enzymatic compositions can optionally include a sanitizing agent (or antimicrobial agent). Sanitizing agents, also known as antimicrobial agents, are chemical compositions that can be used to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, anilides, organosulfur and sulfur-nitrogen compounds and miscellaneous compounds.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, viruses, yeasts, spores, and fungus microorganisms. In use, the antimicrobial agents are typically formed into a solid functional material that when diluted and dispensed, optionally, for example, using an aqueous stream, forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Examples of suitable antimicrobial agents include, but are not limited to, phenolic antimicrobials such as pentachlorophenol; orthophenylphenol; chloro-p-benzylphenols; p-chloro-m-xylenol; quaternary ammonium compounds such as alkyl dimethylbenzyl ammonium chloride; alkyl dimethylethylbenzyl ammonium chloride; octyl decyldimethyl ammonium chloride; dioctyl dimethyl ammonium chloride; and didecyl dimethyl ammonium chloride. Examples of suitable halogen containing antibacterial agents include, but are not limited to: sodium trichloroisocyanurate, sodium dichloro isocyanate (anhydrous or dihydrate), iodine-poly(vinylpyrrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, and tetramethyl phosphonium tribromide. Other antimicrobial compositions such as hexahydro-1,3,5-tris(2-hydroxyethyl)-s-triazine, dithiocarbamates such as sodium dimethyldithiocarbamate, and a variety of other materials are known in the art for their antimicrobial properties.

It should also be understood that active oxygen compounds, such as those discussed above in the bleaching agents section, may also act as antimicrobial agents, and can even provide sanitizing activity. In fact, in some embodiments, the ability of the active oxygen compound to act as an antimicrobial agent reduces the need for additional antimicrobial agents within the composition. For example, percarbonate compositions have been demonstrated to provide excellent antimicrobial action.

### Activators

In some embodiments, the antimicrobial activity of the enzymatic compositions can be enhanced by the addition of a material which, when the enzymatic system is placed in use, reacts with the active oxygen to form an activated component. For example, in some embodiments, a peracid or a peracid salt is formed. In some embodiments, tetraacetylethylene diamine can be included within the enzymatic compositions to react with the active oxygen and form a peracid or a peracid salt that acts as an antimicrobial agent. Other examples of active oxygen activators include transition metals and their compounds, compounds that contain a carboxylic, nitrile, or ester moiety, or other such compounds known in the art. In an embodiment, the activator includes tetraacetylethylene diamine; transition metal; a compound including carboxylic, nitrile, amine, or ester moiety; or mixtures thereof. In some embodiments, an activator for an active oxygen compound combines with the active oxygen to form an antimicrobial agent.

In some embodiments, an activator material for the active oxygen is coupled to the solid block. The activator can be coupled to the solid block by any of a variety of methods for coupling one solid detergent composition to another. For example, the activator can be in the form of a solid that is bound, affixed, glued or otherwise adhered to the solid block. Alternatively, the solid activator can be formed around and encasing the block. By way of further example, the solid activator can be coupled to the solid block by the container or package for the detergent composition, such as by a plastic wrap, shrink wrap or film.

### pH Buffering Agents

Additionally, the enzymatic compositions can be formulated such that during use in aqueous operations, for example in aqueous cleaning operations, the wash water will have a desired pH. For example, a souring agent may be added to the compositions such that the pH of the textile approximately matches the proper processing pH. The souring agent is a mild acid used to neutralize residual alkalines and reduce the pH of the textile such that when the garments come into contact with human skin, the textile does not irritate the skin Examples of suitable souring agents include, but are not limited to: phosphoric acid, formic acid, acetic acid, hydrofluorosilicic acid, saturated fatty acids, dicarboxylic acids, tricarboxylic acids, and any combination thereof. Examples of saturated fatty acids include, but are not limited to: those having 10 or more carbon atoms such as palmitic acid, stearic acid, and arachidic acid (C₂₀). Examples of dicarboxylic acids include, but are not limited to: oxalic acid, tartaric acid, glutaric acid, succinic acid, adipic acid, and sulfamic acid. Examples of tricarboxylic acids include, but are not limited to: citric acid and tricarballylic acids. Examples of suitable commercially available souring agents include, but are not limited to: TurboLizer, Injection Sour, TurboPlex, AdvaCare 120 Sour, AdvaCare 120 Sanitizing Sour, CarboBrite, and Econo Sour, all available from Ecolab Inc., St. Paul, Minn.

### Anti-Redeposition Agents

The enzymatic compositions can optionally include an additional anti-redeposition agent capable of facilitating sustained suspension of soils in a cleaning solution and preventing the removed soils from being redeposited onto the substrate being cleaned. Examples of suitable anti-redeposition agents include, but are not limited to: fatty acid amides, fluorocarbon surfactants, complex phosphate esters, polyacrylates, styrene maleic anhydride copolymers, and cellulosic derivatives such as hydroxyethyl cellulose and hydroxypropyl cellulose.

### Dispersants

The enzymatic compositions may also include dispersants. Examples of suitable dispersants that can be used in the solid detergent composition include, but are not limited to: maleic acid/olefin copolymers, polyacrylic acid, and mixtures thereof.

### Hardening Agents/Solubility Modifiers

The enzymatic compositions may include a minor but effective amount of a hardening agent. Examples of suitable hardening agents include, but are not limited to: an amide such stearic monoethanolamide or lauric diethanolamide, an alkylamide, a solid polyethylene glycol, a solid EO/PO block copolymer, starches that have been made water-soluble through an acid or alkaline treatment process, and various inorganics that impart solidifying properties to a heated composition upon cooling. Such compounds may also vary the solubility of the composition in an aqueous medium during use such that the cleaning agent and/or other active ingredients may be dispensed from the solid composition over an extended period of time.

### Dyes and Fragrances

Various dyes, odorants including perfumes, and other aesthetic enhancing agents may also be included in the enzymatic compositions. Dyes may be included to alter the appearance of the compositios, as for example, any of a variety of FD&C dyes, D&C dyes, and the like. Additional suitable dyes include Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keystone Aniline and Chemical), Metanil Yellow (Keystone Aniline and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), Pylakor Acid Bright Red (Pylam), and the like. Fragrances or perfumes that may be included in the compositions include, for example, terpenoids such as citronellol, aldehydes such as amyl cinnamaldehyde, a jasmine such as C1S-jasmine or jasmal, vanillin, and the like.

### Adjuvants

The enzymatic compositions can also include any number of adjuvants. Specifically, the enzymatic compositions can include stabilizing agents, wetting agents, foaming agents, corrosion inhibitors, biocides and hydrogen peroxide among any number of other constituents which can be added to the composition. Such adjuvants can be pre-formulated with the present composition or added to the system simultaneously, or even after, the addition of the present composition. The enzymatic compositions can also contain any number of other constituents as necessitated by the application, which are known and which can facilitate the activity of the present compositions.

### Embodiments of the Present Compositions

Each of the first and second enzymatic compositions can be provided in various concentrated forms. For example, the enzymatic compositions can be cast, extruded, pressed or in powder or concentrated liquid form. Suitable exemplary concentrate compositions for solid and liquid forms of the first and second enzymatic compositions of the enzymatic system are provided in Tables 1-4.

TABLE 1
First Enzymatic Composition - Solid

| | First Range | Second Range | Third Range |
|---|---|---|---|
| Component | (Wt %) | (Wt %) | (Wt %) |
| Enzyme | 5-20 | 10-18 | 12-16 |
| Solidification Agent | 10-30 | 12-25 | 15-22 |
| Solvent/Processing Agent | 0.1-5 | 0.5-4.5 | 0.75-3 |
| Filler | 10-75.6 | 12-59.6 | 15.75-49.3 |
| Enzyme Stabilization Agent | 0.2-5 | 0.3-4 | 0.4-3 |
| Chelating Agent | 1-5 | 2-4.5 | 2.5-4 |
| Water Conditioning Agent | 5-30 | 10-25 | 12-22 |
| Preservative | 1-5 | 1.5-4.5 | 2-4 |
| Builder | 2-10 | 4-10 | 6-10 |
| Dye | 0.001-1 | 0.003-0.5 | 0.01-0.25 |

TABLE 2
First Enzymatic Composition - Liquid

| | First Range (Wt | Second Range | Third Range |
|---|---|---|---|
| Component | %) | (Wt %) | (Wt %) |
| Water | 62.66-93.13 | 68.86-89.53 | 73.29-87.06 |
| Enzyme | 1-4 | 2-3.6 | 2.4-3.2 |
| Solidification Agent | 2-6 | 2.4-5 | 3-4.4 |
| Solvent/Processing | 0.02-1 | 0.1-0.9 | 0.15-0.6 |
| Agent | | | |
| Filler | 2-15.14 | 2.4-11.94 | 2.8-9.868 |
| Enzyme Stabilization | 0.04-1 | 0.06-0.8 | 0.08-0.6 |
| Agent | | | |
| Chelating Agent | 0.2-1 | 0.4-0.9 | 0.5-0.8 |
| Water Conditioning | 1-6 | 2-5 | 2.4-4.4 |
| Agent | | | |
| Preservative | 0.2-1 | 0.3-0.9 | 0.4-0.8 |
| Builder | 0.4-2 | 0.8-2 | 1.2-2 |
| Dye | 0.0002-0.2 | 0.0006-0.1 | 0.002-0.05 |

TABLE 3
Second Enzymatic Composition - Solid

| | First Range | Second Range | Third Range |
|---|---|---|---|
| Component | (Wt %) | (Wt %) | (Wt %) |
| Enzyme | 5-20 | 10-18 | 12-16 |
| Solidification Agent | 10-30 | 12-25 | 15-22 |
| Solvent/Processing Agent | 0.1-5 | 0.5-1.5 | 0.75-1.25 |
| Filler | 10-75.6 | 12-59.8 | 17.5-49.3 |
| Enzyme Stabilization Agent | 0.2-5 | 0.3-4.5 | 0.4-3 |
| Chelating Agent | 1-10 | 2-9.5 | 2.5-4 |
| Water Conditioning Agent | 5-30 | 10-25 | 12-22 |
| Preservative | 1-5 | 1.5-4 | 2-4 |
| Builder | 2-10 | 4-10 | 6-10 |
| Dye | 0.001-1 | 0.003-0.5 | 0.01-0.25 |

TABLE 4
Second Enzymatic Composition - Liquid

| | First Range | Second Range | Third Range |
|---|---|---|---|
| Component | (Wt %) | (Wt %) | (Wt %) |
| Water | 61.66-93.13 | 68.42-89.57 | 73.63-87.06 |
| Enzyme | 1-4 | 2-3.6 | 2.4-3.2 |
| Solidification Agent | 2-6 | 2.4-5 | 3-4.4 |
| Solvent/Processing Agent | 0.02-1 | 0.1-0.3 | 0.15-0.25 |
| Filler | 2-15.14 | 2.4-11.98 | 2.8-9.868 |
| Enzyme Stabilization | 0.04-1 | 0.02-0.9 | 0.08-0.6 |
| Agent | | | |
| Chelating Agent | 0.2-2 | 0.4-1.9 | 0.5-0.8 |
| Water Conditioning | 1-6 | 2-5 | 2.4-4.4 |
| Agent | | | |
| Preservative | 0.2-1 | 0.3-0.8 | 0.4-0.8 |
| Builder | 0.4-2 | 0.8-2 | 1.2-2 |
| Dye | 0.0002-0.2 | 0.0006-0.1 | 0.002-0.05 |

In one embodiment, the first and second enzymatic compositions of the enzymatic system may be made via an extrusion process. The solidification agent and solvent/processing agent are pre-blended into a molten liquid premix held above the melting point of the solidification agent. In one embodiment, the premix is held at a temperature of at least about 130° F. The premix is continuously fed into the extruder in correct proportion to feeds of all other items. Within the extruder, the liquid is cooled as it is mixed to form a homogenous mixture with the other materials. In an exemplary embodiment, the components of the solid detergent composition are mixed for approximately 1 minute. The blended mass is conveyed toward the end of the extruder and gradually begins to solidify. As the product reaches the end of the extruder it is formed into a specific cross-sectional shape while being compressed and driven out by the material behind it. As it leaves the extruder, the product is cut at specific lengths to form individual blocks that are further cooled by ambient air to complete solidification while being conveyed to the packaging area. They are then shrink-wrapped, labeled and placed into cases.

In one embodiment, the first and second enzymatic compositions may be cast. When the enzymatic compositions are cast, the enzymes are encapsulated in the solidification agent, such as polyethylene glycol (PEG), preventing the absorption of water into the system. This increases the life of the enzymes within the compositions, and therefore the life of compositions.

In one embodiment, the enzymatic compositions may be provided as a concentrate such that the enzymatic compositions are substantially free of any added water or the concentrate may contain a nominal amount of water. The concentrate can be formulated without any water or can be provided with a relatively small amount of water in order to reduce the expense of transporting the concentrate. For example, the composition concentrate can be provided as a capsule or pellet of compressed powder, a solid, or loose powder, either contained by a water soluble material or not. If the composition is delivered via a capsule or pellet, the composition can be introduced into a volume of water, and if present the water soluble material can solubilize, degrade, or disperse to allow contact of the composition concentrate with the water. For the purposes of this disclosure, the terms “capsule” and “pellet” are used for exemplary purposes and are not intended to limit the delivery mode of the invention to a particular shape.

In one embodiment, the concentrate composition can be provided in a solid form that resists crumbling or other degradation until placed into a container. Such container may either be filled with water before placing the composition concentrate into the container, or it may be filled with water after the composition concentrate is placed into the container. In either case, the solid concentrate composition dissolves, solubilizes, or otherwise disintegrates upon contact with water. In a preferred embodiment, the solid concentrate composition dissolves rapidly thereby allowing the concentrate composition to become a use composition and further allowing the end user to apply the use composition to a surface in need of cleaning.

In another embodiment, the solid concentrate composition can be diluted through dispensing equipment whereby water is sprayed at the solid block forming the use solution. The water flow is delivered at a relatively constant rate using mechanical, electrical, or hydraulic controls and the like. The solid concentrate composition can also be diluted through dispensing equipment whereby water flows around the solid block, creating a use solution as the solid concentrate dissolves. The solid concentrate composition can also be diluted through pellet, tablet, powder and paste dispensers, and the like. In one embodiment, each of the first and second enzymatic compositions is automatically dispensed at a rate of about 0.25 to about 1 ounce per gallon. However, the dispensing rate will depend in part on the quality of the water used to dilute the enzymatic system and the application of the enzymatic system.

It is expected that the concentrate will be diluted with the water of dilution in order to provide a use solution having a desired level of detersive properties. If the use solution is required to remove tough or heavy soils, it is expected that the concentrate can be diluted with the water of dilution at a weight ratio of at least about 1:1 and up to about 1:8. If a light duty detergent use solution is desired, it is expected that the concentrate can be diluted at a weight ratio of concentrate to water of dilution of up to about 1:256. The ratio may depend in part on the hardness of the water of dilution. The water of dilution can be characterized as hard water when it includes at least about 1 GPG water hardness. It is expected that the water of dilution can include at least about 5 GPG water hardness, at least about 10 GPG water hardness, or at least about 20 GPG water hardness.

In an alternate embodiment, the solid enzymatic compositions may be provided as a ready-to-use (RTU) composition. If the solid enzymatic compositions are provided as a RTU composition, a more significant amount of water is added to the detergent compositions as a diluent. When the concentrate is provided as a liquid, it may be desirable to provide it in a flowable form so that it can be pumped or aspirated. It is generally difficult to accurately pump a small amount of a liquid. It is generally more effective to pump a larger amount of a liquid. Accordingly, although it is desirable to provide the concentrate with as little as possible in order to reduce transportation costs, it is also desirable to provide a concentrate that can be dispensed accurately.

In the case of a RTU composition, it should be noted that the above-disclosed detergent composition may, if desired, be further diluted with up to about 98 wt % water, based on the weight of the solid enzymatic compositions.

In use, the enzymatic system is delivered in two separate steps. The first enzymatic composition is dispensed in a first step and is formulated to remove blood and hemoglobin from the surface of the device being cleaned. The first enzymatic composition is diluted with cold water having a temperature of about 50° F. to about 120° F. during a first wash step. In one embodiment, the first enzymatic composition is diluted such that the use solution has a concentration of about 0.25 to about 1 ounce per gallon. Once the first enzymatic composition has been diluted, the first enzymatic composition is allowed to contact the surface to be washed for an amount of time to effectively remove the soils from the surface. In an exemplary embodiment, the use solution of the first enzymatic composition remains on the surface for at least about 1 minute to about 3 minutes.

The second enzymatic composition is dispensed in a second step and is formulated to remove biomasses such as mucous, fibrin, fats and hemoglobin from the surfaces of the device being cleaned. The second enzymatic composition is diluted with hot water having a temperature of about 140° F. to about 180° F. and is dispensed during a main detergent wash step. In one embodiment, the second enzymatic composition is diluted such that the use solution has a concentration of about 0.25 to about 1 ounce per gallon. Once the second enzymatic composition has been diluted, the second enzymatic composition is allowed to contact the surface to be washed for an amount of time to effectively remove the soils from the surface. In an exemplary embodiment, the use solution of the second enzymatic composition remains on the surface for at least about 1 minute to about 8 minutes.

The surface of the device being washed is then rinsed to remove the first and second enzymatic compositions. In one embodiment, the surfaces are subjected to a series of rinses. For example, the surfaces may be sent through a hot water rinse, a thermal rinse and a pure water rinse.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Materials Used

Solid Enzymatic Detergent: an enzymatic composition of the present invention with component concentrations as shown in Table 5. The enzyme used was Alcalase, a low temperature protease available from Novozymes, Denmark. The composition also included PEG 4000, a polyethylene glycol available from BASF Corporation, Florham Park, N.J.; Proxel GXL, a 1, 2 benzisothiazolin-3(2H)-one preservative available from Arch Chemicals, Atlanta, Ga.; Acticide B 20, a 1, 2 benzisothiazolin-3(2H)-one preservative available from Thor, Speyer, Germany and Acusol 445 ND, a solid acrylate polymer having a molecular weight of about 4,5000 g/mol available from Dow Chemical Company, Midland, Mich.

TABLE 5
Solid Enzymatic Detergent

| Component | (Wt %) |
|---|---|
| Enzyme | 12-16 |
| Solidification Agent | 15-22 |
| Solvent/Processing Agent | 0.75-3 |
| Filler | 15.75-49.3 |
| Enzyme Stabilization Agent | 0.4-3 |
| Chelating Agent | 2.5-4 |
| Water Conditioning Agent | 12-22 |
| Preservative | 2-4 |
| Builder | 6-10 |
| Dye | 0.01-0.25 |

Solid Neutral Detergent: an enzymatic composition of the present invention with component concentrations as shown in Table 6 below. The enzyme used was Experase 12MG, a high temperature protease available from Novozymes, Denmark. The composition also included PEG 4000, a polyethylene glycol available from BASF Corporation, Florham Park, N.J.; Proxel GXL, a 1, 2 benzisothiazolin-3(2H)-one preservative available from Arch Chemicals, Atlanta, Ga.; Acticide B 20, a 1, 2 benzisothiazolin-3(2H)-one preservative available from Thor, Speyer, Germany and Acusol 445 ND, a solid acrylate polymer having a molecular weight of about 4,5000 g/mol available from Dow Chemical Company, Midland, Mich.

TABLE 6
Solid Neutral Detergent

| Component | (Wt %) |
|---|---|
| Enzyme | 12-16 |
| Solidification Agent | 15-22 |
| Solvent/Processing Agent | 0.75-1.25 |
| Filler | 17.5-49.3 |
| Enzyme Stabilization Agent | 0.4-3 |
| Chelating Agent | 2.5-4 |
| Water Conditioning Agent | 12-22 |
| Preservative | 2-4 |
| Builder | 6-10 |
| Dye | 0.01-0.25 |

Dissolvine GL PD: a glutamic acid, N,N-diacetic acid, tetrasodium salt available from Azko Nobel Functional Chemicals, Amersfoort, Germany.

PowerCon Triple Enzyme: an enzymatic composition available from Getinge, Rochester, N.Y.

PowerCon Neutral pH Detergent: a detergent composition available from Getinge, Rochester, N.Y.

Prolystica Ultra Concentrate Enzyme: an enzymatic composition available from Steris Corporation, Mentor, Ohio.

Prolystica Ultra Concentrate Neutral Detergent: a detergent composition available from Steris Corporation, Mentor, Ohio.

### Cleaning Ability—TOSI Ratings

To determine the cleaning effectiveness of several enzymatic systems, a plurality of TOSI coupons were washed in a Steris 444 type wash machine while being subjected to the Instrument Cycle. TOSI coupons are pre-manufactured with blood soils and are available from Pereg GmbH, Waldkraiburg, Germany. The blood soils on TOSI coupons are designed to directly correlate to and simulate the cleaning challenges of surgical instruments and provide a consistent, repeatable, and reliable method for evaluating the cleaning effectiveness of an automated instrument washer or cleaning composition. When metered on to a stainless steel plate, the TOSI coupons are analogous to a stainless steel instrument soiled with dried blood.

The TOSI coupons were washed using various first enzymatic compositions and second enzymatic compositions. About 1 oz/gallon of a first enzymatic composition and about 1 oz/gallon of a second enzymatic composition were used. The coupons were first exposed to the first enzymatic composition for about 1 minute. Cold tap water was used during the first wash step.

When determining cleaning limitations, the coupons were then exposed to the second enzymatic composition, which was diluted with hot tap water, for about 3 minutes. This step was followed by a detergent wash, lasting about 5 minutes.

When determining cleaning performance against comparative compositions, the coupons were then exposed to the second enzymatic composition, which was diluted with hot tap water, for about 1 minute. This step was followed by a detergent wash, lasting about 2 minutes.

During the detergent wash, the tap water was gradually heated to about 160° F. by the automated washer heating device. The coupons were then rinsed with hot tap water for about 1 minute, followed by a thermal rinse for about 1 minute at a temperature of about 180° F. Lastly, the coupons were rinsed with pure, deionized water for about 10 seconds. Other than the pure rinse, the tests were carried out using either 5 or 17 GPG water.

The test used a 2-factor general factorial 6×3 crossed design. The first factor, cleaner type, had 6 levels, including various first enzymatic compositions and second enzymatic compositions. The second factor was the location of the coupon in the washer. The washer included 3 pairs of baskets in a vertical arrangement: upper, middle and lower. Location 1 was the left side of the left upper basket. Location 2 was the center of the left middle basket and Location 3 was the right side of the right lower basket. Four replicates (wash cycles) were made using each of the first enzymatic composition and second enzymatic composition combinations.

The cleanliness of each of the TOSI coupons was evaluated after the first wash step and after the second wash step. The evaluations were based on a scale of 0 to 4. A TOSI rating of 0 indicated that the test soil is completely dissolved and that there is only minor fibrin residue remaining A TOSI rating of 1 indicated that no water soluble proteins are visible but there is still a small layer of fibrin material present such that the enzymatic system is cleaning water-soluble proteins but not the insoluble ones. A TOSI rating of 2 indicated that no water soluble proteins are visible, but that most or all of the fibrin layer and a minor hemoglobin residue remains such that the fibrin is being dissolved, but some of the water-soluble proteins remain. A TOSI rating of 3 indicated that small residuals of the water soluble proteins are visible and that no only or a little amount of fibrin layer remains visible. A TOSI rating of 4 indicated that significant residuals of the water soluble proteins are visible and most or all of the fibrin layer remains. A TOSI rating of 5 indicated that the test soils are largely or completely remaining.

The compositions of the system of the present invention included Solid Enzymatic Detergent as a first enzymatic composition and Solid Neutral Detergent as a second enzymatic composition.

The comparative systems included combinations of commercially available products. In particular, the first comparative system included Prolystica Ultra Concentrate Enzyme as a first enzymatic composition and Prolystica Ultra Concentrate Neutral Detergent as a second enzymatic composition. The second comparative system included PowerCon Triple Enzyme as a first enzymatic composition and PowerCon Neutral pH Detergent as a second enzymatic composition. Water was used as a control.

### TOSI Coupons Using 5 GPG Water Hardness (1 oz Dosage)

Table 7 shows the average ratings of the TOSI coupons after being exposed to the first enzymatic compositions at various locations within the machine. The TOSI coupons were rated based on the cleaning performance of each of the first enzymatic compositions.

TABLE 7

| | TOSI Rating |
|---|---|
| Solid Enzymatic Detergent | 2 |
| Prolystica Ultra Concentrate Enzyme | 1.75 |
| PowerCon Triple Enzyme | 2.5 |
| Water | 2.67 |

Statistical analysis of the data in Table 7 shows that there is no significant differences between the performance of the Solid Enzymatic Detergent and the performances of the Prolystica Ultra Concentrate Enzyme and the PowerCon Triple Enzyme. There was also no statistical difference between the performance of the enzymatic compositions and water. This is not surprising because in this step, the soiled surface was being prepared for cleaning. TOSI coupons are generally used to measure cleaning efficiency, not to access preparedness.

Table 8 shows the ratings of the TOSI coupons after being exposed to the first enzymatic compositions and the second enzymatic compositions. The TOSI coupons were rated based on the cleaning performance of each of the first and second enzymatic composition combinations.

TABLE 8

| | TOSI Rating |
|---|---|
| Solid Enzymatic Detergent + Solid Neutral Detergent | 0.06 |
| Prolystica Ultra Concentrate Enzyme + Prolystica | 0.71 |
| Ultra Concentrate Neutral Detergent | |
| PowerCon Triple Enzyme + PowerCon Neutral pH | 1 |
| Detergent | |
| Water | 1.83 |

As can be seen by the data in Table 8, when the TOSI coupons were exposed to the entire enzymatic system, the enzymatic system of the present invention including the Solid Enzymatic Detergent and Solid Neutral Detergent resulted in the lowest TOSI ratings, consistently performing better than the Prolystica Ultra Concentrate Enzyme and Prolystica Ultra Concentrate Neutral Detergent system and the PowerCon Triple Enzyme and PowerCon Neutral pH Detergent system.

As expected, all of the systems performed better than water at removing soils.

### TOSI Coupons Using 17 GPG Water (1 oz Dosage)

Table 9 shows the average ratings of the TOSI coupons after being exposed to the first enzymatic compositions and the second enzymatic compositions. The TOSI coupons were rated based on the cleaning performance of each of the first and second enzymatic compositions combinations.

TABLE 9

| | TOSI Rating |
|---|---|
| Solid Enzymatic Detergent + Solid Neutral Detergent | 0.67 |
| Prolystica Ultra Concentrate Enzyme + Prolystica | 1.33 |
| Ultra Concentrate Neutral Detergent | |
| PowerCon Triple Enzyme + PowerCon Neutral pH | 2.17 |
| Detergent | |
| Water | 1.33 |

As can be seen by the data in Table 9, the results are similar to those in Table 8. When the TOSI coupons were exposed to the entire enzymatic system of the present invention, the lowest TOSI ratings resulted, consistently performing better than the Prolystica Ultra Concentrate Enzyme and Prolystica Ultra Concentrate Neutral Detergent system and the PowerCon Triple Enzyme and PowerCon Neutral pH Detergent system.

### TOSI Coupons Using 17 GPG Water Hardness (0.75 oz Dosage)

Table 10 shows the average ratings of the TOSI coupons after being exposed to the first enzymatic compositions and the second enzymatic compositions. The TOSI coupons were rated based on the cleaning performance of each of the first and second enzymatic composition combinations.

TABLE 10

| | TOSI Rating |
|---|---|
| Solid Enzymatic Detergent + Solid Neutral Detergent | 0.5 |
| Prolystica Ultra Concentrate Enzyme + Prolystica | 1.67 |
| Ultra Concentrate Neutral Detergent | |
| PowerCon Triple Enzyme + PowerCon Neutral pH | 1.83 |
| Detergent | |

Table 10 illustrates that the Solid Enzymatic Detergent and Solid Neutral Detergent system resulted in a lower TOSI rating than the system of Prolystica Ultra Concentrate Enzyme and Prolystica Ultra Concentrate Neutral Detergent and the system of PowerCon Triple Enzyme and PowerCon Neutral pH Detergent. In particular, the system of Solid Enzymatic Detergent and Solid Neutral Detergent was the only combination that received an average rating of less than 1.

### TOSI Coupons Using 5 GPG Water Hardness

To determine cleaning limitations, the enzymatic compositions of the present invention were tested. Table 11 shows the average ratings of the TOSI coupons after being exposed to the first enzymatic composition of the present invention, the second enzymatic composition of the present invention, and the enzymatic system of the present invention. The TOSI coupons were rated based on the cleaning performance of each of the first and second enzymatic compositions and the enzymatic combination.

The compositions were tested at use solution concentrations of 30 ppm, 60 ppm and 235 ppm. The 30 ppm use solution was based on a 1.5% sump solution at 0.25 oz/gal. The 60 ppm use solution was based on a 3% sump solution at 0.25 oz/gal. The 235 ppm use solution was based on a 4% sump solution at 0.75 oz/gal.

TABLE 11

| | TOSI Rating | | |
|---|---|---|---|
| | 30 ppm | 60 ppm | 235 ppm |
| Solid Enzymatic Detergent | Not tested | Not tested | 0.78 |
| Solid Neutral Detergent | 1 | 0.5 | 0.67 |
| Solid Enzymatic Detergent + Solid | 0.5 | 0.67 | 0 |
| Neutral Detergent | | | |

As can be seen by the results listed in Table 11, there was no significant difference between the performance of Solid Enzymatic Detergent and Solid Neutral Detergent using 5 GPG water hardness. The concentration of Solid Neutral Detergent also did not have a significant effect on the performance of the composition.

### TOSI Coupons Using 17 GPG Water Hardness

To determine cleaning limitations, the enzymatic compositions of the present invention were tested. Table 12 shows the average ratings of the TOSI coupons after being exposed to the first enzymatic composition of the present invention, the second enzymatic composition of the present invention, and the enzymatic system of the present invention. The TOSI coupons were rated based on the cleaning performance of each of the first and second enzymatic compositions and the enzymatic combination.

The compositions were tested at use solution concentrations of 30 ppm, 60 ppm and 235 ppm. The 30 ppm use solution was based on a 1.5% sump solution at 0.25 oz/gal. The 60 ppm use solution was based on a 3% sump solution at 0.25 oz/gal. The 235 ppm use solution was based on a 4% sump solution at 0.75 oz/gal.

TABLE 12

| | TOSI Rating | | |
|---|---|---|---|
| | 30 ppm | 60 ppm | 235 ppm |
| Solid Enzymatic Detergent | — | — | 1.22 |
| Solid Neutral Detergent | 1 | 1.17 | 1.33 |
| Solid Enzymatic Detergent + Solid | 0.67 | 0.83 | 0 |
| Neutral Detergent | | | |

As can be seen by the results listed in Table 12, there was no significant difference between the performance of Solid Enzymatic Detergent and Solid Neutral Detergent using 17 GPG water hardness. The concentration of Solid Neutral Detergent also did not have a significant effect on the performance of the composition. When Solid Enzymatic Detergent and Solid Neutral Detergent were used in combination, the TOSI ratings improved.

### Cleaning Ability—Wash-Checks Coupons

To determine the cleaning effectiveness of several enzymatic systems, a plurality of Wash-Checks coupons were washed using various first enzymatic compositions and second enzymatic compositions. Wash-Checks coupons are pre-manufactured with blood soils and are available from Steritec Products Inc., Castle Rock, Colo. The blood soils on Wash-Checks coupons are designed to directly correlate to, and simulate, the cleaning challenges of surgical instruments and provide a consistent, repeatable, and reliable method for evaluating the cleaning effectiveness of an automated instrument washer or cleaning composition. When metered onto a stainless steel plate, the Wash-Checks coupons are analogous to a stainless steel instrument soiled with dried blood.

About 1 oz/gallon of a first enzymatic composition and about 1 oz/gallon of a second enzymatic composition were used. Before washing the coupons, the amount of soil on the coupons was measured and recorded. The coupons were first exposed to the first enzymatic composition for about 1 minute. Cold tap water was used during the first wash step.

The coupons were then exposed to the second enzymatic composition, which was diluted with hot tap water, for about 3 minutes. This step was followed by a detergent wash, lasting about 2 minutes. During the detergent wash, the tap water heater was gradually heated to about 160° F.

The coupons were then rinsed with hot tap water for about 1 minute, followed by a thermal rinse for about 1 minute at a temperature of about 180° F. Lastly, the coupons were rinsed with pure, deionized water for about 10 seconds. Other than the pure rinse, the tests were carried out using 5 GPG water. The percent soil remaining on the coupons was then measured and recorded.

The test used a 2-factor general factorial 6×3 crossed design. The first factor, cleaner type, had 6 levels, including various first enzymatic compositions and second enzymatic compositions. The second factor was the location of the coupon in the washer. The washer included 3 pairs of baskets in a vertical arrangement: upper, middle and lower. Location 1 was the left side of the left upper basket. Location 2 was the center of the left middle basket and Location 3 was the right side of the right lower basket. Four replicates (wash cycles) were made using each of the first enzymatic composition and second enzymatic composition combinations.

The system of the present invention included Solid Enzymatic Detergent as a first enzymatic composition and Solid Neutral Detergent as a second enzymatic composition.

The comparative systems included combinations of commercially available products. In particular, the first comparative system included Prolystica Ultra Concentrate Enzyme as a first enzymatic composition and Prolystica Ultra Concentrate Neutral Detergent as a second enzymatic composition. The second comparative system included PowerCon Triple Enzyme as a first enzymatic composition and PowerCon Neutral pH Detergent as a second enzymatic composition. Water was used as a control.

Table 13 shows the percent of soil removed from the Wash-Checks coupons after being exposed to the first enzymatic compositions and the second enzymatic compositions. Table 13 also shows the average amount of soil each of the combinations removed from the Wash-Checks coupons.

TABLE 13
(Wash-Checks First Enzymatic Composition + Second Enzymatic
Composition -3 5 GPG Water)

| | Soil Removal |
|---|---|
| | (%) |
| Solid Enzymatic Detergent + Solid Neutral Detergent | 73 |
| Prolystica Ultra Concentrate Enzyme + Prolystica | 65 |
| Ultra Concentrate Neutral Detergent | |
| PowerCon Triple Enzyme + PowerCon Neutral pH | 78 |
| Detergent | |
| Water | 44 |

As can be seen from the data in Table 13, the Solid Enzymatic Detergent and Solid Neutral Detergent system removed substantially the same percentage of soil from the Wash-Checks coupons as the system of PowerCon Triple Enzyme and PowerCon Neutral pH Detergent and outperformed the system of Prolystica Ultra Concentrate Enzyme and Prolystica Ultra Concentrate Neutral Detergent.

### Cleaning Ability—Total Organic Carbon (TOC) Test

An additional technique used to assess the cleaning ability of the enzymatic systems on TOSI coupons was to chemically assess the total organic carbon (TOC) on the TOSI coupons and to compare it to a base amount of TOC on unused TOSI coupons. The TOC is the amount of carbon bound in an organic compound. The TOC test measures low levels of organic carbon by collecting the residue from the surface of the TOSI coupon with a swab and extracting it into an aqueous solution for analysis.

Surface residue was collected by wiping a defined area with a moistened swab and then extracting the residue from the swab into an aqueous solution for TOC analysis. The water based sample was introduced into an analyzer by an autosampler and H₃PO₄ was injected into the sample to reduce the pH to 2 to allow for accurate measurement of total carbon (TC) and inorganic carbon (IC). The acidified sample was then combined with persulfate to promote oxidation of the organics and then split into two equal but separate flows. One stream was processed for the measurement of IC and the other was processed for measurement of TC. The TC stream was passed into the oxidation reactor and was exposed to UV light which produced highly reactive sulfate and hydroxyl free radicals. The sulfate, hydroxyl free radicals and the persulfate completely oxidized the organic compounds in the sample, converting carbon to CO₂. The CO₂ from the TC and IC sample streams were measured by the respective conductivity cells and the conductivity readings were used to calculate the concentrations of TC and IC. The difference between the TC and IC concentrations is the TOC concentration.

For each TOSI coupon that was swabbed there was a corresponding TOC vial. Each TOC vial was filled with 40 mL high purity water and capped. Immediately prior to swabbing the coupon surface, the swab was submerged in the corresponding TOC vial that was filled with high purity water. The excess water was removed from the swab head by pressing against the inside of the container wall so that water droplets would not form if held at any angle. The surface of the TOSI coupon was then swabbed. Halfway through the swabbing process the swab was dipped back into the TOC vial to remove some of the organics and to rewet the swab. The swab head was then broken off into a TOC vial using a cleaned metal snip. The vials were then sonicated for a minimum of about 30 minutes in a sonicator filled with water to a level just below the caps of the vials. Following sonication, the vials were uncapped and the swab heads were removed from the vials using clean, fine tipped metal tongs. The swab was analyzed with a TOC instrument according to the instrument SOP A&P 99009. The TOC analysis quantifies the organic carbon from the hemoglobin, albumin and fibrin on the TOSI coupon.

The base amount of TOC was estimated by averaging the TOC measurement of 5 new TOSI coupons. The average TOC level was about 55.8 ppm.

The system of the present invention included Solid Enzymatic Detergent as a first enzymatic composition and Solid Neutral Detergent as a second enzymatic composition.

The comparative systems included combinations of commercially available products. In particular, the first comparative system included Prolystica Ultra Concentrate Enzyme as a first enzymatic composition and Prolystica Ultra Concentrate Neutral Detergent as a second enzymatic composition. The second comparative system included PowerCon Triple Enzyme as a first enzymatic composition and PowerCon Neutral pH Detergent as a second enzymatic composition. Water was used as a control.

Table 14 shows the amount of TOC present on the TOSI coupons after being exposed to the Solid Enzymatic Detergent and Solid Neutral Detergent system, the PowerCon Triple Enzyme and PowerCon Neutral pH Detergent system and the Prolystica Ultra Concentrate Enzyme and Prolystica Ultra Concentrate Neutral Detergent system in 5 GPG water. The control was 5 GPG water.

TABLE 14

| | TOC |
|---|---|
| | Average |
| | (μg) |
| Solid Enzymatic Detergent + Solid Neutral Detergent | 5.5 |
| Prolystica Ultra Concentrate Enzyme + Prolystica | 4.3 |
| Ultra Neutral Detergent | |
| PowerCon Triple Enzyme + PowerCon Neutral pH | 5.4 |
| Detergent | |
| Water | 21.3 |

The data in Table 14 illustrates that the system of the present invention performed substantially similarly to the PowerCon Triple Enzyme and PowerCon Neutral pH Detergent system and the Prolystica Ultra Concentrate Enzyme and Prolystica Ultra Concentrate Neutral Detergent system, commercially available products, at lowering the amount of TOC from TOSI coupons.

The average difference in the amount of TOC remaining at the different locations was less than about 10%, so the location effect was considered insubstantial.

Table 15 shows the amount of TOC present on the TOSI coupons after being exposed to the combination of Solid Enzymatic Detergent and Solid Neutral Detergent, the combination of PowerCon Triple Enzyme and PowerCon Neutral pH Detergent and the combination of Prolystica Ultra Concentrate Enzyme and Prolystica Ultra Concentrate Neutral Detergent in 17 GPG water. The control used 17 GPG water.

TABLE 15

| | TOC |
|---|---|
| | Average |
| | (μg) |
| Solid Enzymatic Detergent + Solid Neutral Detergent | 2.9 |
| Prolystica Ultra Concentrate Enzyme + Prolystica | 2.4 |
| Ultra Neutral Detergent | |
| PowerCon Triple Enzyme + PowerCon Neutral pH | 7.6 |
| Detergent | |
| Water | 19.3 |

The data in Table 15 illustrates that the compositions of the present invention perform substantially similarly to PowerCon Triple Enzyme and PowerCon Neutral pH Detergent and Prolystica Ultra Concentrate Enzyme and Prolystica Ultra Concentrate Neutral Detergent, two commercially available products, at lowering the amount of TOC from TOSI coupons.

### Cleaning Ability—TOSI and Wash-Checks Coupons

The enzymatic system of the present invention was tested for its cleaning ability with regard to TOSI coupons and Wash-Checks coupons. With regard to the TOSI coupons, the enzymatic system was considered to pass if the TOSI coupons had no red residue or only slight residue remaining on the surface of the TOSI coupon after being exposed to the enzymatic system of the present invention. With respect to the Wash-Checks coupons, the enzymatic system was considered to pass if the Wash-Checks coupons had no white or red residue remaining on the surface of the Wash-Checks coupon after being exposed to the enzymatic system of the present invention.

Table 16 shows whether the Solid Enzymatic Detergent and Solid Neutral Detergent combination passed the tests at various locations within the machine.

TABLE 16

| | TOSI Coupons | | | Wash-Checks Coupons | | |
|---|---|---|---|---|---|---|
| | Top | Middle | Bottom | Top | Middle | Bottom |
| Solid Enzymatic | Pass | Pass | Pass | Pass | Pass | Pass |
| Detergent + | | | | | | |
| Solid Neutral | | | | | | |
| Detergent | | | | | | |

As illustrated in Table 16, the Solid Enzymatic Detergent and Solid Neutral Detergent combination was effective at removing soils from the TOSI coupons and the Wash-Checks Coupons at all locations.

### Effect of Additional Components

Various tests were performed to determine whether the cleaning performance of the enzymatic composition of the present invention was enhanced by any of the other components in the compositions. The tests were performed using 5 GPG water and 17 GPG water. An objective rating was done using a HunterLab Instrument and the EMPA 116 type system. The EMPA 116 type system test fabric is uniformly stained with blood, milk and Japanese ink and is suitable for establishing the effectiveness of detergents containing proteases. The percent soil removal was calculated using the following formula:

% Soil Removal=((L2−L1)/(L1−STD))*100

A subjective reading was also taken with the coupons being rated on a scale of 0 to 5. A rating of 0 indicated that the coupon was visually clean. A rating of 5 indicated that almost no soil had been removed. The pH of each of the component was measured to ensure that they were within the neutral range (5-9) in order to ensure enzyme preservation.

The components tested included sodium citrate, sodium sulfate, kitchen salt, PEG 4000, PEG 8000, sodium gluconate and deionized water. The components and respective pHs are summarized below in Table 17.

TABLE 17

pH

| | 5 GPG | 17 GPG |
|---|---|---|
| Sodium Citrate | 8.01 | 7.65 |
| Sodium Sulfate | 8.08 | 7.39 |
| Kitchen Salt | 7.9 | 7.47 |
| PEG 4000 | 7.7 | 7.59 |
| PEG 8000 | 7.71 | 7.4 |
| Sodium Gluconate | 7.6 | 7.34 |
| DI Water | 7.7 | 7.43 |

As can be seen in Table 17, all of the components were within the neutral range at both 5 GPG and 17 GPG.

Table 18 lists the EMPA 116 type percent soil removal after just the first wash step and after the first wash step and second wash step.

TABLE 18

| | EMPA 116 Type Soil Removal (%) | | | |
|---|---|---|---|---|
| | 5 GPG | | 17 GPG | |
| | First | First + | First | First + |
| | Wash | Second Wash | Wash | Second Wash |
| Sodium Citrate | 7.6 | 22.7 | 3.2 | 7.3 |
| Sodium Sulfate | 9.3 | 11.9 | 2.2 | 4.0 |
| Kitchen Salt | 7.0 | 10.1 | 1.9 | 2.2 |
| PEG 4000 | 7.6 | 9.3 | 0.3 | 0.6 |
| PEG 8000 | 5.4 | 8.4 | 2.1 | 1.8 |
| Sodium Gluconate | 4.6 | 8.0 | 1.3 | 1.4 |
| DI Water | 6.4 | 6.7 | 1.2 | 1.5 |

Table 18 illustrates that when 5 GPG water was used, all of the above components removed within about 5% the same amount of soil after the first wash step. After only the first wash step, sodium sulfate removed the most amount of soil, while sodium gluconate removed the least amount of soil. However, after both the first wash and second wash steps, sodium citrate removed the most amount of soil, while deionized water removed the least amount of soil.

When 17 GPG water was used, the sodium citrate removed the most amount of soil both after the first wash step and after the first wash and second wash steps. The PEG 4000 removed the least amount of soil at both conditions.

Table 19 lists the TOSI ratings after the first wash step and after the first and second wash steps.

TABLE 19

| TOSI Rating | |
|---|---|
| 5 GPG | 17 GPG |

| | | First + | | First + |
|---|---|---|---|---|
| | First | Second | First | Second |
| | Wash | Wash | Wash | Wash |
| Sodium Citrate | 2 | 2 | 2 | 2 |
| Sodium Sulfate | 1 | 1 | 2 | — |
| Kitchen Salt | 2 | 2 | 2 | 2 |
| PEG 4000 | 2 | 1 | 2 | 2 |
| PEG 8000 | 2 | 2 | 2 | 1 |
| Sodium Gluconate | 2 | 2 | 2 | 2 |
| DI Water | 2 | 2 | 2 | 2 |

The results shown in Tables 18 and 19 illustrate that fillers are useful and important components in the cleaning process. The fillers and polymers of propylene glycol may be ineffective individually, but are useful in combination. Tables 18 and 19 also show that generally, lower grain water is more useful in cleaning than higher grain water.

### Chelating Test

A chelating test was performed to determine what effect various amounts of bicarbonate and an additional chelating agent would have on the alkalinity of the compositions and to compare the chelation values of various samples.

Compositions of the present invention included Solid Enzymatic Detergent with various levels of bicarbonate and a chelating agent, Dissolvine. The control included Solid Enzymatic Detergent and 10% bicarbonate.

The comparative compositions included commercially available products. In particular, the comparative compositions included Prolystica Ultra Concentrate Enzyme and Prolystica Ultra Concentrate Neutral Detergent.

Each solution was first analyzed for its pH at 5% concentration using a Metrohm 780 pH Meter. The pH of the solution relates to the preservation of the enzymes, with a desired pH in the neutral range (pH 5-9), and particularly close to the pH of the control. The pH of each of the solutions is noted below in Table 20.

TABLE 20

| | pH |
|---|---|
| Solid Enzymatic Detergent | 7.79 |
| Solid Enzymatic Detergent + 5% bicarbonate + 3% Dissolvine | 8.38 |
| Solid Enzymatic Detergent + 3% Dissolvine | 8.65 |
| Solid Enzyme + 10% bicarbonate | 8.73 |
| Prolystica Ultra Concentrate Enzyme | 6.79 |
| Prolystica Ultra Concentrate Neutral Detergent | 7.70 |

From the control, it was determined that in order to preserve the enzymes in the solutions, the solutions should have a pH of about 8 to about 9. Each solution was then analyzed at its 5% concentration to determine the chelation value of the solution. First, the percent solids were calculated. The percent solids of the compositions are shown below in Table 21.

TABLE 21

| | % Solids |
|---|---|
| Solid Enzymatic Detergent | 4.86 |
| Solid Enzymatic Detergent + 5% bicarbonate + 3% Dissolvine | 4.93 |
| Solid Enzymatic Detergent + 3% Dissolvine | 4.86 |
| Solid Enzyme + 10% bicarbonate | 4.86 |
| Prolystica Ultra Concentrate Enzyme | 2.29 |
| Prolystica Ultra Concentrate Neutral Detergent | 2.03 |

To determine the ability of the solutions to chelate calcium, sodium carbonate was first added to the compositions at increments of about 0.2 grams, to chelate Ca²⁺. The pH of the solution was maintained at about 11. Because the pH of the composition may decrease with the addition of the sodium carbonate, sodium hydroxide was added in amounts sufficient to maintain the composition at a pH of 11. Once the sodium carbonate was added and the pH was adjusted to 11, the composition was titrated with calcium acetate hydrate at about 0.25 mL increments until calcium carbonate began to precipitate out of solution. The first sign of the calcium carbonate precipitate at pH 11 was considered the endpoint of the titration. Table 22 lists the weight, mL of titrant, mg of calcium carbonate per gram, and mg of calcium carbonate per gram at the use solution of each of the compositions.

TABLE 22

| | Weight | Titrant | mg | mg CaCO₃/gram at |
|---|---|---|---|---|
| | (g) | (mL) | CaCO₃/gram | use concentration |
| Solid Enzymatic Detergent | 20.0151 | 4.75 | 12.21 ± 0.64 | 9.16 ± 0.48 |
| Solid Enzymatic Detergent + 5% | 20.0331 | 3.50 | 8.86 ± 0.63 | 6.65 ± 0.47 |
| bicarbonate + 3% Dissolvine | | | | |
| Solid Enzymatic Detergent + 3% | 20.0214 | 4.50 | 11.56 ± 0.64 | 8.67 ± 0.48 |
| Dissolvine | | | | |
| Solid Enzymatic Detergent + | 20.0041 | 2.75 | 7.07 ± 0.64 | 5.30 ± 0.48 |
| 10% bicarbonate | | | | |
| Prolystica Ultra Concentrate | 50.0135 | 0.50 | 1.09 ± 0.54 | 0.90 ± 0.44 |
| Enzyme | | | | |
| Prolystica Ultra Concentrate | 49.9810 | 4.50 | 11.09 ± 0.62 | 10.11 ± 0.56 |
| Neutral Detergent | | | | |

The compositions were analyzed at about 1 gram dry material where the specific gravity of the composition of the control was assumed to be about 1 g/mL, the specific gravity of the Prolystica Ultra Concentrate Enzyme was about 1.03 g/mL and the specific gravity of the Prolystica Ultra Concentrate Neutral Detergent was about 1.14 g/mL. The use concentration of the control was 0.75 oz/gallon of a 5% solution, or about 0.3 mL/L. The use concentration of the Prolystica Ultra Concentrate Enzyme and Prolystica Ultra Concentrate Neutral Detergent were 0.10 oz/gallon, or about 0.8 mL/L. The following equations were used to determine the mg CaCO₃/gram:

mg CaCO₃/gram=((mL titrant)(0.25))/((dry weight)(0.1)),

where

dry weight=(solution weight)(% solids)/100

As can be seen in Table 22, the chelating abilities of Solid Enzymatic Detergent and Solid Enzymatic Detergent+3% Dissolvine are substantially similar to the chelating abilities of Prolystica Ultra Concentrate Enzyme and Prolystica Ultra Concentrate Neutral Detergent, two commercially available detergents. To further demonstrate the chelating abilities of the composition of the present invention with the comparative compositions, it was determined that the compositions of Solid Enzymatic Detergent, Solid Enzymatic Detergent+5% bicarbonate+3% Dissolvine, Solid Enzymatic Detergent+3% Dissolvine, and Solid Enzymatic Detergent+10% bicarbonate, would need to be diluted 2.69 times more to get to the concentrations of the compositions of Prolystica Ultra Concentrate Enzyme and Prolystica Ultra Concentrate Neutral Detergent (0.8 mL/L). In other words, the compositions of Prolystica Ultra Concentrate Enzyme and Prolystica Ultra Concentrate Neutral Detergent would need to be further diluted by a factor of about 37.1% to get to the same concentrations as the compositions of the present invention (0.3 mL/L). These results are shown below in Table 23.

TABLE 23

| | mg CaCO₃/gram | mg CaCO₃/gram at |
|---|---|---|
| | 0.8 mL/L use | 0.3 mL/L use |
| | concentration | concentration |
| Solid Enzymatic Detergent | 24.6 | 9.16 |
| Solid Enzymatic Detergent + 5% bicarbonate + | 17.9 | 6.65 |
| 3% Dissolvine | | |
| Solid Enzymatic Detergent + 3% Dissolvine | 12.3 | 8.67 |
| Solid Enzymatic Detergent + 10% bicarbonate | 14.2 | 5.30 |
| Prolystica Ultra Concentrate Enzyme | 0.90 | 0.33 |
| Prolystica Ultra Concentrate Neutral Detergent | 10.1 | 3.75 |

A second chelating test was performed to determine chelation capabilities of various compositions. Compositions of the present invention included Solid Enzymatic Detergent and Solid Neutral Detergent.

The compositions of the comparative compositions included various commercially available products. In particular, the comparative compositions included Prolystica Ultra Concentrate Enzyme, Prolystica Ultra Concentrate Neutral Detergent, PowerCon Triple Enzyme and PowerCon Neutral pH Detergent.

For each product, a 4% solution (w/v) was made and analyzed by QATM 262, Total Solids or Volatiles by Microwave Drying Techniques to determine the percent solids. Table 24 lists the percent solids of each 4% solution and the percent solids for each solution.

TABLE 24

| | % Solids of | |
|---|---|---|
| | the 4% solution | % Solids |
| Solid Enzymatic Detergent | 3.93 | 98.25 |
| Solid Neutral Detergent | 3.78 | 94.50 |
| Prolystica Ultra Concentrate Enzyme | 1.66 | 41.50 |
| Prolystica Ultra Concentrate Neutral | 1.45 | 36.25 |
| Detergent | | |
| PowerCon Triple Enzyme | 0.51 | 12.75 |
| PowerCon Neutral pH Detergent | 1.28 | 32.00 |

The 4% solution (w/w) was then analyzed by QATM 072, Calcium Chelation to determine the calcium chelation capacity of each solution. Using the specific gravity of each product and the use solution directions for each product, the calcium chelation value was calculated for each composition at its use solution using the formula given above. The use concentration (g/L) was calculated by taking the specific gravity of the product times the use concentration (mL/L). The use concentration (dry weight (g)/L) was calculated by taking the % solids for the product times the use concentration (g/L). The use concentration (dry weight (g)/L), was then multiplied by the calcium chelation value determined by QATM 072.

Table 25 lists the weight, mL of titrant, mg of calcium carbonate per gram and mg of calcium carbonate per gram at the use solution of each of the compositions.

TABLE 25

| | | | | mg CaCO₃/L of |
|---|---|---|---|---|
| | Weight (g) | Titrant (mL) | mg CaCO₃/g | Product at Use Conc. |
| Solid Enzymatic Detergent | 25.0220 | 4.25 | 10.81 ± 0.64 | 2.44 ± 0.14 |
| Solid Neutral Detergent | 25.0103 | 4.75 | 12.56 ± 0.66 | 2.73 ± 0.14 |
| Prolystica Ultra Concentrate Enzyme | 60.9530 | 0.50 | 1.24 ± 0.62 | 0.42 ± 0.21 |
| Prolystica Ultra Concentrate Neutral | 60.7314 | 3.75 | 10.65 ± 0.71 | 3.52 ± 0.23 |
| Detergent | | | | |
| PowerCon Triple Enzyme | 80.4561 | 0.50 | 3.05 ± 1.52 | 1.52 ± 0.76 |
| PowerCon Neutral pH Detergent | 80.0663 | 5.50 | 13.42 ± 0.61 | 20.09 ± 0.91 |

From this comparison, it is shown that both the Solid Enzymatic Detergent and Solid Neutral Detergent have better calcium chelation properties than the Prolystica® Ultra Concentrate Enzymatic Cleaner and the PowerCon™ Triple Enzyme Detergent Concentrate. Further comparison can be demonstrated by how the calcium chelation properties would change depending on each product's use concentration. These results are shown below in Table 26.

The chelating abilities were measured and calculated at a concentration of 0.23 mL/L (the use concentration of Solid Enzymatic Detergent and Solid Neutral Detergent), a concentration of 0.80 mL/L (the use concentration of Prolystica Ultra Concentrate Enzyme and Prolystica Ultra Concentrate Neutral Detergent) and a concentration of 3.9 mL/L (the use concentration of PowerCon Triple Enzyme and PowerCon Neutral pH Detergent). The data for a concentration of 0.23 mL/L was experimental for the Solid Enzymatic Detergent and Solid Neutral Detergent and calculated for the remaining compositions; the data for a concentration 0.80 mL/L was experimental for the Prolystica Ultra Concentrate Enzyme and Prolystica Ultra Concentrate Neutral Detergent and calculated for the remaining compositions and the data for a concentration 0.80 mL/L was experimental for the PowerCon Triple Enzyme and PowerCon Neutral pH Detergent and calculated for the remaining compositions.

Table 26 shows the chelating abilities of the compositions at various concentrations.

TABLE 26

| | Use Concentration | | |
|---|---|---|---|
| | (mL/L) | | |
| | 0.23 | 0.80 | 3.9 |
| Solid Enzymatic Detergent | 2.44 | 8.49 | 41.37 |
| Solid Neutral Detergent | 2.73 | 9.50 | 46.29 |
| Prolystica Ultra Concentrate Enzyme | 0.12 | 0.42 | 2.05 |
| Prolystica Ultra Concentrate Neutral | 1.01 | 3.52 | 17.16 |
| Detergent | | | |
| PowerCon Triple Enzyme | 0.09 | 0.31 | 1.52 |
| PowerCon Neutral pH Detergent | 1.18 | 4.12 | 20.09 |

The results in Table 26 illustrate that Solid Enzymatic Detergent and Solid Neutral Detergent have higher calcium chelating capabilities than other commercially available products at the same dilutions.

### Foaming Tests

To determine the level of foam produced by various first and second enzymatic compositions at use solution concentrations, a foaming test was performed at 118.4° F. and at about 160° F. The enzymatic compositions were tested at a 1% dilution rate using 5 GPG cold city tap water. About 25 mL of the enzymatic compositions were poured into a cylinder and the cylinder was stoppered. From a vertical position, the cylinder was rotated about 120 degrees and back to the vertical position. This was repeated 50 times at a frequency of about 1 cycle per second. The cylinder was then placed on a flat surface and the foam and liquid levels were allowed to separate for about 30 seconds.

Readings were taken after 0 seconds (right after shaking), and after 30 seconds. The foam height was measured as the difference between the top of the liquid level and the top of the foam level. The top of the foam level was the level where the foam was opaque and not transparent. Lower foam height values are desirable for intended applications of the present invention.

The compositions of the present invention included Solid Enzymatic Detergent and Solid Neutral Detergent.

The compositions of the comparative compositions included various commercially available products. In particular, the comparative compositions included Prolystica Ultra Concentrate Enzyme, Prolystica Ultra Concentrate Neutral Detergent, PowerCon Triple Enzyme and PowerCon Neutral pH Detergent.

Table 27 shows the initial foam height and the foam height at 30 seconds after shaking The first enzymatic compositions were tested at about 118.4° F. and the second enzymatic compositions were tested at about 160° F. Each of the compositions was tested using 5 GPG and 17 GPG water.

TABLE 27

| | Height at | Height at | Height at | Height at |
|---|---|---|---|---|
| | 0 seconds | 30 seconds | 0 seconds | 30 seconds |
| | 5 GPG | | 17 GPG | |
| Solid Enzymatic | 12 | 0 | 5.67 | 0 |
| Detergent | | | | |
| Solid Neutral | 7 | 0 | 6.67 | 0 |
| Detergent | | | | |
| PowerCon Triple | 2.67 | 0.67 | 4 | 1 |
| Enzyme | | | | |
| PowerCon Neutral | 1.67 | 0.33 | 0.67 | 0 |
| pH Detergent | | | | |
| Prolystica Ultra | 7.33 | 1.33 | 2.33 | 0 |
| Concentrate Enzyme | | | | |
| Prolystica Ultra | 8.00 | 0.33 | 5.37 | 0 |
| Concentrate Neutral | | | | |
| Detergent | | | | |

As can be seen in Table 27, at 5 GPG water, the average change in foam height for Solid Enzymatic Detergent was substantially greater than either Prolystica Ultra Concentrate Enzyme or PowerCon Ultra Concentrate Enzyme. At 17 GPG, the average change in foam height for Solid Enzymatic Detergent was substantially greater than Prolystica Ultra Concentrate Enzyme.

At both 5 and 17 GPG, the average change in foam height for Solid Enzymatic Neutral was significantly greater than PowerCon Ultra Concentrate Neutral Detergent.

A second foaming test was performed at room temperature and at about 122° F. The second foaming test was performed using only the first enzymatic compositions at a 1% solution. All other conditions were the same as the foaming test performed above. The composition of the present invention included Solid Enzymatic Detergent.

The compositions of the comparative compositions included various commercially available products. In particular, the comparative compositions included Enzycare 2, available from Steris Corporation, Mentor, Ohio; Endozime AW Triple Plus, available from Ruhof Corporation, Mineola, N.Y.; PowerCone Triple Enzyme, available from Getinge, Rochester, N.Y.; and Prolystica Ultra Concentrate Enzyme, available from Steris Corporation.

Table 28 shows the initial foam height and the foam height at 30 seconds after shaking at room temperature and at about 122° F. for each of the compositions.

TABLE 28

| | Foam Height | Foam Height | Foam Height | Foam Height | |
|---|---|---|---|---|---|
| | at 0 seconds | at 30 seconds | at 0 seconds | at 30 seconds | |
| | Room Temperature | | 122° F. | | Comments |
| Solid Enzymatic | 21 | 2 | 17 | 2 | Very “airy” bubbles |
| Detergent | | | | | |
| Enzycare 2 | 12 | 1 | 8 | 0 | During some of the test |
| | | | | | runs, there was a small |
| | | | | | amount of foam on the |
| | | | | | edges and none in the |
| | | | | | center |
| Endozime AW | 11 | 10 | 10 | 8 | — |
| Triple Plus | | | | | |
| PowerCone | 4 | 2 | 2 | 1 | Solution is cloudy at |
| Triple Enzyme | | | | | RT and 122° F. |
| Prolystica Ultra | 47 | 41 | 47 | 35 | — |
| Concentrate | | | | | |
| Enzyme | | | | | |

As can be seen in Table 28, at 30 seconds, Solid Enzymatic Detergent performed substantially similarly to Enzycare 2 and PowerCon Triple Enzyme, two commercially available products. Solid Enzymatic Detergent also outperformed Endozime AW Triple Plus and Prolystica Ultra Concentrate Enzyme.

The data also shows that at room temperature, although Solid Enzymatic Detergent did foam initially, it quickly broke down to a very small foam after about 30 seconds. Enzycare 2 was the only other composition that foamed initially but then broke down quickly. Endozime AW Triple Plus and Prolystica Ultra Concentrate Enzyme all foamed, but did not break much after 30 seconds.

Table 28 also illustrates that at about 122° F., Solid Enzymatic Detergent does foam initially, but again broke down quickly to a small amount of foam after about 30 seconds. Enzycare 2, again, was the only other composition that foamed initially and broke down quickly. In fact, Enzycare 2 broke to no foam on the surface. Endozime AW Triple Plus and Prolystica Ultra Concentrate Enzyme all foamed, but did not break down as much as Solid Enzymatic Detergent. While they did break slightly, there was still a relatively large amount of foam on the surface.

### Water Hardness Tolerance Test

To determine the ability of the compositions to tolerate hard water, various enzymatic compositions were tested at varying degrees of water hardness. A water hardness solution of calcium chloride and magnesium was prepared by adding about 33.45 grams of calcium chloride and about 23.24 grams of magnesium chloride in a 1 liter volumetric flask and diluted to volume with deionized water. 1 milliliter of the solution equaled about 2 grams per grain (GPG) hardness.

A NaHCO₃ solution was prepared by adding about 56.25 grams of sodium bicarbonate to a 1 liter volumetric flask and diluted to volume with deionized water.

A test solution was prepared by adding about 4 grams of Solid Enzymatic Detergent into deionized water to obtain about a 4% concentration of the solution.

About 1000 mLs of deionized water and about 5 mL of the NaHCO₃ solution were added to each beaker. The water hardness solution was then added to the beaker to achieve the desired water hardness. To obtain 2 GPG water hardness, about 1 mL of the water hardness solution was added. For 4 GPG, about 2 mL of the water hardness solution was added, etc.

The test solution was added to the beaker in an amount to obtain a 320 ppm use solution. The solutions in the beakers were thoroughly mixed and heated to about 160° F.

The initial transmittance of the solutions was then measured using a spectrophotometer. The transmittance of the solutions was then taken again after about 30 minutes for a final transmittance reading.

The transmittance readings of compositions including about 4 GPG water, about 6 GPG water, about 8 GPG water, about 10 GPG water, about 12 GPG water, about 14 GPG water and about 16 GPG water were measured. Table 29 shows the initial and final transmittance readings at the varying water hardness levels.

TABLE 29

| Hardness | Initial Reading | Final Reading |
|---|---|---|
| Level (GPG) | (% T) | (% T) |
| 4 | 100 | 100 |
| 6 | 100 | 100 |
| 8 | 101 | 100 |
| 10 | 100 | 100 |
| 12 | 99 | 99 |
| 14 | 99 | 99 |
| 16 | 98 | 99 |

All of the enzymatic compositions were visually clear. As can be seen in Table 29, at all water hardness levels, all of the compositions had high initial and final transmittance readings. Generally, the initial and final transmittance readings remained the same at all water hardness levels. Although the compositions showed 100% transmittance readings at 4 GPG to 10 GPG, compositions including up to 16 GPG still had transmittance readings of at least about 98%.

### Metal Compatibility Test

To determine the compatibility of the enzymatic compositions of the present invention with various metals, the enzymatic compositions were tested on various metals. The metals included: brass type 353 (brass 353), copper type 10 (copper 10), aluminum type 1001 (Al 1001), stainless steel type 430 (SS430), stainless steel type 316 (SS316), aluminum type 3003 (Al3003), aluminum type 6061 (Al6061) and anodized aluminum (anodized AL). A series of tests were run using elemental analysis by inductively-coupled plasma (ICP), which detects up to 24 metals and measures the weight of the coupons before and after washing.

The metal coupons were exposed to the compositions of the present invention as they would be in an actual automated washer disinfector. One set of metals was subjected to a solution of Solid Enzymatic Detergent and another set of metals was subjected to a solution of the Solid Neutral Detergent. Both solutions were generated from a 6% sump concentration at 1 oz/gal dosage. The exposure time of the coupons was equivalent to surgical instruments being used for two years being reprocessed twice a day.

The first set of metal coupons was statically soaked in the Solid Enzymatic Detergent in an oven heated to about 122° F. for about 38 hours. This is equivalent to a 3 minute exposure time, once a day for two years. The second set of metal coupons was statically soaked in the Solid Neutral Detergent in an oven heated to about 160° F. for about 62 hours. This is equivalent to a 5 minute exposure time, once a day for two years.

Table 30 shows the types and parts per million of metals detected when each of the coupons was exposed to the Solid Enzymatic Detergent at 122° F., the Solid Neutral Detergent at 160° F. and 5 GPG water at 122° F. and at 160° F.

TABLE 30

| | | Metal Detected (ppm) | | | | | | |
|---|---|---|---|---|---|---|---|---|
| | | Al | Cu | Fe | Ni | Pb | Mn | Zn |
| Aluminum | Solid Enzymatic Detergent | 13.8 | 0.488 | 0 | 0 | 0 | 0 | 0 |
| 1001 | 5 GPG Water at 122° F. | 4.95 | 0 | 0 | 0 | 0 | 0 | 0 |
| | Solid Neutral Detergent | 14 | 0.314 | 0 | 0 | 0 | 0 | 0 |
| | 5 GPG Water at 160° F. | 15 | 0 | 0 | 0 | 0 | 0 | 0 |
| Anodized | Solid Enzymatic Detergent | 4.61 | 0.63 | 0 | 0.0672 | 0 | 0 | 0 |
| Aluminum | 5 GPG Water at 122° F. | 1.32 | 0 | 0 | 0 | 0 | 0 | 0 |
| | Solid Neutral Detergent | 11.1 | 0.685 | 0.604 | 0.0774 | 0 | 0 | 0 |
| | 5 GPG Water at 160° F. | 3.6 | 0 | 0 | 0 | 0 | 0 | 0 |
| Aluminum | Solid Enzymatic Detergent | 2.34 | 0 | 0 | 0 | 0 | 0 | 0 |
| 3003 | 5 GPG Water at 122° F. | 6.61 | 0 | 0 | 0 | 0 | 0.056 | 0 |
| | Solid Neutral Detergent | 125 | 0 | 0 | 0 | 0.295 | 0 | 0 |
| | 5 GPG Water at 160° F. | 4.85 | 0 | 0 | 0 | 0 | 0.0741 | 0 |
| Aluminum | Solid Enzymatic Detergent | 2.87 | 0 | 0 | 0 | 0 | 0 | 0 |
| 6061 | 5 GPG Water at 122° F. | 7.18 | 0.57 | 0.107 | 0 | 0 | 0 | 0 |
| | Solid Neutral Detergent | 15.3 | 0.278 | 0 | 0 | 0 | 0 | 0 |
| | 5 GPG Water at 160° F. | 6.36 | 0 | 0 | 0 | 0 | 0 | 0 |
| SS-316 | Solid Enzymatic Detergent | 0 | 0.19 | 0 | 0 | 0 | 0 | 0 |
| | 5 GPG Water at 122° F. | 0 | 0.589 | 0 | 0 | 0 | 0 | 0 |
| | Solid Neutral Detergent | 0.44 | 0.263 | 0 | 0 | 0 | 0 | 0 |
| | 5 GPG Water at 160° F. | 0 | 0.141 | 0 | 0 | 0 | 0 | 0 |
| SS-430 | Solid Enzymatic Detergent | 0 | 0.638 | 0.213 | 0 | 0 | 0 | 0 |
| | 5 GPG Water at 122° F. | 0 | 0.205 | 0 | 0 | 0 | 0 | 0 |
| | Solid Neutral Detergent | 0 | 0.365 | 0 | 0 | 0 | 0 | 0 |
| | 5 GPG Water at 160° F. | 0 | 0 | 0.132 | 0 | 0 | 0 | 0 |
| Copper 10 | Solid Enzymatic Detergent | 0 | 0.361 | 0 | 0 | 0 | 0 | 0 |
| | 5 GPG Water at 122° F. | 0 | 4.99 | 0 | 0 | 0 | 0 | 0 |
| | Solid Neutral Detergent | 0 | 19.7 | 0 | 0 | 0 | 0 | 0 |
| | 5 GPG Water at 160° F. | 0 | 0.105 | 0 | 0 | 0 | 0 | 0 |
| Brass | Solid Enzymatic Detergent | 0 | 3.64 | 0 | 0 | 2.72 | 0 | 1.56 |
| | 5 GPG Water at 122° F. | 0 | 0.205 | 0 | 0 | 0 | 0 | 0.161 |
| | Solid Neutral Detergent | 0 | 4.36 | 0 | 0 | 2.95 | 0 | 1.25 |
| | 5 GPG Water at 160° F. | 0 | 1.63 | 0 | 0 | 0 | 0 | 0 |

As can be seen by the data in Table 30, the amounts of metals detected in the solutions were negligible. The greatest amount of metal detected was about 15 ppm aluminum from the Aluminum 6061 coupon when a coupon was washed with Solid Neutral Detergent. However, even 5 GPG water resulted in about 6 ppm aluminum when exposed to the coupon at the same temperature. Generally, if a metal was detected when the coupon was washed with either Solid Enzymatic Detergent or Solid Neutral Detergent, the metal was also detected when the coupon was washed with 5 GPG water at the same temperature.

Table 31 shows the weights of the metal coupons before and after washing with Solid Enzymatic Detergent at 122° F., Solid Neutral Detergent at 160° F. and 5 GPG water at 122° F. and at 160° F.

TABLE 31

| | | Weight (g) | | | |
|---|---|---|---|---|---|
| | | Initial | Final | Difference | % Difference |
| Aluminum | Solid Enzymatic Detergent | 5.46685 | 5.4667 | 0.00015 | 0.002742 |
| 1001 | 5 GPG Water at 122° F. | 5.48235 | 5.4824 | −5E−05 | −0.00091 |
| | Solid Neutral Detergent | 5.49255 | 5.4924 | 0.00015 | 0.00273 |
| | 5 GPG Water at 160° F. | 5.4882 | 5.49205 | −0.00385 | −0.07018 |
| Anodized | Solid Enzymatic Detergent | 5.6895 | 5.6962 | −0.0067 | −0.11776 |
| Aluminum | 5 GPG Water at 122° F. | 5.67145 | 5.67995 | −0.0085 | −0.15005 |
| | Solid Neutral Detergent | 5.672 | 5.68155 | −0.00955 | −0.16837 |
| | 5 GPG Water at 160° F. | 5.66215 | 5.6685 | −0.00635 | −0.11212 |
| Aluminum | Solid Enzymatic Detergent | 5.3842 | 5.38425 | −5E−05 | −0.00092 |
| 3031 | 5 GPG Water at 122° F. | 5.40985 | 5.41015 | −0.0003 | −0.00553 |
| | Solid Neutral Detergent | 5.4278 | 4.92795 | 0.49985 | 9.209411 |
| | 5 GPG Water at 160° F. | 5.4197 | 5.4206 | −0.0009 | −0.01661 |
| Aluminum | Solid Enzymatic Detergent | 5.5705 | 5.5706 | −0.0001 | −0.00179 |
| 6063 | 5 GPG Water at 122° F. | 5.60325 | 5.6029 | 0.00035 | 0.006262 |
| | Solid Neutral Detergent | 5.5584 | 5.55795 | 0.00045 | 0.008111 |
| | 5 GPG Water at 160° F. | 5.5756 | 5.5757 | −1E−04 | −0.0018 |
| SS-316 | Solid Enzymatic Detergent | 15.40655 | 15.40685 | −0.0003 | −0.00195 |
| | 5 GPG Water at 122° F. | 15.2805 | 15.2806 | −1E−04 | −0.00065 |
| | Solid Neutral Detergent | 15.28065 | 15.28115 | −0.0005 | −0.00327 |
| | 5 GPG Water at 160° F. | 15.162 | 15.1623 | −0.0003 | −0.00198 |
| SS-430 | Solid Enzymatic Detergent | 8.5491 | 8.54945 | −0.00035 | −0.0041 |
| | 5 GPG Water at 122° F. | 8.47985 | 8.4798 | 5E−05 | 0.000594 |
| | Solid Neutral Detergent | 8.49385 | 8.4938 | 5E−05 | 0.000593 |
| | 5 GPG Water at 160° F. | 8.16465 | 8.16515 | −0.0005 | −0.00608 |
| Copper | Solid Enzymatic Detergent | 27.18945 | 27.1894 | 5E−05 | 0.000182 |
| | 5 GPG Water at 122° F. | 27.1485 | 27.1483 | 0.0002 | 0.000732 |
| | Solid Neutral Detergent | 27.082 | 27.08145 | 0.00055 | 0.002031 |
| | 5 GPG Water at 160° F. | 27.08815 | 27.09 | −0.00185 | −0.00683 |
| Brass | Solid Enzymatic Detergent | 27.44705 | 27.4467 | 0.00035 | 0.001273 |
| | 5 GPG Water at 122° F. | 27.4709 | 27.4711 | −0.0002 | −0.00073 |
| | Solid Neutral Detergent | 27.4394 | 27.4395 | −1E−04 | −0.00036 |
| | 5 GPG Water at 160° F. | 27.3996 | 27.39875 | 0.00085 | 0.003104 |

As can be seen by the data in Table 31, the weight of the metal coupons did not change a significant amount from when they were weighed before being washed and after being washed in the solutions. The greatest amount of weight percent change was about 9%, when the Aluminum 3031 coupon was exposed to Solid Neutral Detergent. All other weight changes were about 0.1% or less. This indicates that a negligible amount of the metal coupons were pitted or corroded and removed due to exposure to Solid Enzymatic Detergent or Solid Neutral Detergent.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. An enzymatic system comprising:
(a) a first composition comprising a low temperature enzyme effective at removing blood and hemoglobin; and
(b) a second composition comprising a high temperature enzyme effective at removing mucous, fibrin and fat.

2. The enzymatic system of claim 1, wherein the low temperature enzyme comprises a protease, a lipase or a combination thereof.

3. The enzymatic system of claim 1, wherein the low temperature enzyme has an activation temperature of about 50 to about 120 degrees Fahrenheit.

4. The enzymatic system of claim 1, wherein the high temperature enzyme comprises a protease, a lipase or a combination thereof.

5. The enzymatic system of claim 1, wherein the high temperature enzyme has an activation temperature of about 140 to about 180 degrees Fahrenheit.

6. The enzymatic system of claim 1, wherein the first composition and the second composition have a pH of about 5 to about 9.

7. The enzymatic system of claim 1, wherein each of the first and second compositions further comprise:
(c) a solvent;
(d) an enzyme stabilization agent;
(e) a filler;
(f) a chelating agent; and
(g) a builder.

8. A detergent system for cleaning instruments comprising:
(a) a first pH neutral enzymatic composition comprising about 5% to about 20% of a first enzyme;
(b) a second pH neutral enzymatic composition comprising about 5% to about 20% of a second enzyme;

9. The detergent system of claim 8, wherein each of the first and second enzymatic compositions has a pH of about 5 to about 9.

10. The detergent system of claim 9, wherein each of the first and second enzymatic compositions has a pH of about 8 to about 9.

11. The detergent system of claim 8, wherein the first pH neutral enzymatic composition comprises an enzyme having an activation temperature of about 50 to about 120 degrees Fahrenheit.

12. The detergent system of claim 8, wherein the second pH neutral enzymatic composition comprises an enzyme having an activation temperature of about 140 to about 180 degrees Fahrenheit.

13. The detergent system of claim 8, wherein the first pH neutral enzymatic composition comprises a protease, a lipase or a combination thereof.

14. The detergent system of claim 8, wherein the second pH neutral enzymatic composition comprises a protease, a lipase or a combination thereof.

15. A method of cleaning a surgical instrument comprising:
(a) contacting the surgical instrument in a first enzymatic composition comprising a low temperature enzyme;
(b) washing the surgical instrument in a second enzymatic composition comprising a high temperature enzyme; and
(c) rinsing the surgical instrument.

16. The method of claim 15, wherein contacting the surgical instrument comprises immersing the surgical instrument in water having a temperature of about 50 degrees to about 120 degrees Fahrenheit.

17. The method of claim 15, wherein washing the surgical instrument comprises washing the surgical instrument in water having a temperature of about 140 to about 180 degrees Fahrenheit.

18. The method of claim 15, wherein the low and high temperature enzymes are pH neutral enzymes.

19. The method of claim 15, wherein contacting the surgical instrument in the first enzymatic composition comprises contacting the surgical instrument in the first enzymatic composition for about 1 minute to about 5 minutes.

20. The method of claim 15, wherein the low temperature enzyme comprises a protease, a lipase or a combination thereof and wherein the high temperature enzyme comprises a protease, a lipase or a combination thereof.
